(19) United States
(12) Patent Application Publication
(10) Pub. No.: US 2023/0236033 A1
(43) Pub. Date: Jul. 27, 2023

(54) Method for Generating Personalized Transportation Plans Comprising a Plurality of Route Components Combining Multiple Modes of Transportation

(71) Applicant: Synapse Partners, LLC, Menlo Park, CA (US)

(72) Inventor: Evangelos Simoudis, Menlo Park, CA (US)

(21) Appl. No.: 18/193,588

(22) Filed: Mar. 30, 2023

Related U.S. Application Data
(63) Continuation-in-part of application No. PCT/US2021/052310, filed on Sep. 28, 2021.
(60) Provisional application No. 63/085,564, filed on Sep. 30, 2020.
(60) Provisional application No. 63/121,160, filed on Dec. 3, 2020.

(51) Int. Cl. G01C 21/34; G06Q 30/08

(52) U.S. Cl. CPC G01C 21/3484; G01C 21/3423; G01C 21/3446; G06Q 30/08

(57) ABSTRACT

A personalized transportation plan for multi-modal transportation can be generated from an origin location, a destination location, and a route component server. A route data record might comprise a plurality of route components from the origin to the destination, represented in a route component record comprising indications of a route component start location, a route component end location, and a transportation mode for the route component. Route data records can be filtered based on user constraints determined from a user profile database. The filtered plurality of route data records can be used, with a transportation provider database, to determine a set of transportation option records for a given route component record wherein transportation option records indicate a provider of transportation from the route component start location for the route component record to the route component end location for the route component record. Bid messages can be generated for route components.

### CROSS-REFERENCES TO PRIORITY AND RELATED APPLICATIONS

This application is a continuation-in-part of International Patent Application No. PCT/US2021/052310 filed Sep. 28, 2021 (Attorney Ref. 63945.6WO01), entitled “Transportation Marketplace Systems and Methods,” which claims benefit of and priority from, U.S. Provisional Patent Application No. 63/085,564 filed Sep. 30, 2020, entitled “Transportation Marketplace Systems and Methods,” and U.S. Provisional Patent Application No., 63/121,160, filed on Dec. 3, 2020, entitled “Transportation Marketplace Systems and Methods”.

A related application is PCT/US2019/056352, filed Oct. 15, 2019 (“Simoudis I”).

The entire disclosure(s) of application(s)/patent(s) recited above is(are) hereby incorporated by reference, as if set forth in full in this document, for all purposes.

### FIELD

The present disclosure generally relates to analyzing and filtering transportation data and more particularly to determining transportation plans that use multiple types of transportation.

### BACKGROUND

The rapid expansion in the computing capability of mobile computing devices, such as smartphones, tablet computers and other portable devices, and the growth in the number and advancement of software program applications (or “apps”) for mobile devices, has greatly increased the dependence of individuals on devices, apps and related platforms in the field of personal productivity. For example, apps are widely used for scheduling meetings, determining travel routes, selecting transit modes, and other functions.

The emergence, and acceptance, of mobility services such as consumer adoption of peer-to-peer car sharing and ride-hailing services has encouraged a combination of transportation and mobile applications. Next-generation mobility is about autonomous and automated vehicles, electrified vehicles, and on-demand shared mobility and the use cases they enable. Autonomous vehicles that are capable of operation without human intervention are rapidly improving. As such vehicles are commercialized, they may improve local transportation by providing greater functionality and allowing new methods and systems to be utilized for moving passengers and cargo. One such enabling-functionality is the ability of the vehicle to move from one location to another location in an autonomous manner Challenges may arise as to how to best utilize available transportation and logistics resources, in conjunction with various types of autonomous vehicles.

### SUMMARY

A personalized transportation plan for multi-modal transportation can be generated from an origin location, a destination location, and a route component server. A route data record might comprise a plurality of route components from the origin to the destination, represented in a route component record comprising indications of a route component start location, a route component end location, and a transportation mode for the route component. Route data records can be filtered based on user constraints determined from a user profile database. The filtered plurality of route data records can be used, with a transportation provider database, to determine a set of transportation option records for a given route component record wherein transportation option records indicate a provider of transportation from the route component start location for the route component record to the route component end location for the route component record. Bid messages can be generated for route components.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 schematically shows an example of a network environment in which a personal transportation management system may be operated.

FIG. 2 shows examples of user database, in accordance with some embodiments.

FIG. 3 shows an example of a transportation graph.

FIG. 4 shows an example of a personalized transportation plan.

FIG. 5 shows an example of another personalized transportation plan.

FIG. 6 shows an example process of generating one or more transactional options for a user during a daily transportation.

FIG. 7 shows an example process of providing personalized passenger commerce during transportation.

FIG. 8 schematically shows a transport plan engine in communication with a plurality of databases and sources of data for generating a personalized transportation experience.

FIG. 9 shows a block diagram of a transport plan step creator.

FIG. 10 shows a computer system that is programmed or otherwise configured to implement the personal transportation management system described herein.

FIG. 11 shows an example of a personal transportation management system.

FIG. 12 shows an example of a vehicle database.

FIG. 13 shows examples of data processed or used by the transportation plan generator.

FIG. 14 shows an example of a transportation plan execution engine.

FIG. 15 illustrates an example of the data stored in the user database and vehicle database accessed by various applications.

FIG. 16 illustrates an example of a transportation marketplace platform in accordance with some embodiments.

FIG. 17 schematically shows a marketplace controller in accordance with some embodiments.

FIG. 18 illustrates an example of a graphical user interface displaying multiple options of priced transportation plans.

FIG. 19 shows an example of a transportation mobility measurement.

FIG. 20 shows another example of a transportation mobility measurement.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

With a large number of available transportation options available in some geographic areas, providing information for a user planning a trip might not be scalable. As explained herein, a system for filtering, processing, and presenting information to a user for planning a trip, as well as obtaining transportation options for route components, is provided.

Recognized herein is a need for methods and systems for providing products or services for use with vehicles, such as fully autonomous, pilotless vehicles. Beneficially, such products or services may facilitate savings in both time and resources for users of the vehicles. Additionally, recognized herein is a need for an automated marketplace platform that can allow companies offering those products or services to more directly engage with end consumers in a vehicular transportation environment.

The present disclosure provides systems and methods for generating a personalized transportation experience with customized passenger commerce services. In particular, the personalized transportation experience can involve transportation via autonomous vehicles that do not require a fleet operator. The personalized transportation experience can be provided with any transportation mode, such as, for example, autonomous vehicle, ride-hailing service, fleet-based services, microtransit (e.g., fleet-based demand responsive transit), rail transportation, and/or terrestrial mass transit vehicle. A personalized transportation plan may be generated using a machine learning system with minimal human intervention. The provided systems and methods may allow for a range of new use cases for pilotless/driverless vehicles in industries such as hotels and hospitality, restaurants and dining, tourism and entertainment, healthcare, service delivery, and the like.

The automated marketplace system can be configured to facilitate transactions between the personalized transportation plan system and Transportation Service Providers (TSPs). For instance, the automated marketplace system may receive personalized transportation plans generated by the system herein, post the personalized transportation plan along with a bid request, receive bids from Transportation Service Providers (TSPs) in response to the bid request, from brokers and other intermediaries who in turn seek bids from TSPs or otherwise obtain bids from TSPs and other sources. In addition, the bids can be used for bid estimation, in which participating TSPs may be given an opportunity to engage in a “reverse auction” bid in order to fill a need for obtaining a transportation order. The automated marketplace system may match the offers for services, and, by factoring in pricing to include using real time pricing data generated from by the marketplace.

In an aspect, a method for facilitating transportation services is provided. The method comprises: (a) at a server, receiving a transportation plan, wherein the transportation plan comprises a plurality of components each including at least a transportation mode, an origin location and a destination location associated with a corresponding component; (b) querying a transportation provider database to identify one or more service providers based at least in part on the origin location, the destination location and the transportation mode associated with at least one component from the plurality of components; and (c) sending a bidding request to the one or more transportation providers identified in (b).

In some embodiments, the transportation plan is generated using a machine learning algorithm trained model. In some cases, the transportation plan is generated based at least in part on calendar data, and a to-do list data of a user. In some embodiments, the transportation mode or the destination location is predicted using a machine learning algorithm trained model.

In some embodiments, the transportation provider database is configured to store an operating geographic region and a transportation mode associated with each service provider. In some cases, the one or more service providers are identified by finding a match between the origin location, the destination location, the operating geographic region, and the transportation mode.

In some embodiments, the method further comprises receiving one or more bid prices from the one or more service providers, and transmitting the at least one component and transmitting multiple transportation options each including the transportation plan with the one or more bid prices to a user. In some cases, the method further comprises receiving a user input indicating acceptance of at least one of the multiple transportation options.

In some embodiments, a first transportation mode determined for a first component is different from a second transportation mode determined for a second component of the transportation plan. In some embodiments, the transportation mode is selected from the group consisting of: an autonomous vehicle, a human-driven automated vehicle, a ride-hailing service, a ride-sharing service, rail transportation, a terrestrial mass transit vehicle, bicycle, and e-scooter.

Another aspect of the present disclosure provides a non-transitory computer readable medium comprising machine executable code that, upon execution by one or more computer processors, implements any of the methods above or elsewhere herein. For example, the non-transitory computer-readable storage medium including instructions that, when executed by at least one processor of a computing system, cause the computing system to perform operations comprising: (a) receiving a transportation plan, wherein the transportation plan comprises a plurality of components each including at least a transportation mode, an origin location and destination location of a respective component; (b) querying a transportation provider database to identify one or more service providers based at least in part on an origin location, a destination location and a transportation mode associated with at least one component from the plurality of components; and (c) sending a bidding request to the one or more identified transportation providers.

In another aspect, a method for facilitating commerce while a user is traveling along a travel route may comprise: (a) at a server, receiving a starting geographic location and a destination geographic location of the user; (b) using the starting geographic location and the destination geographic location to generate the travel route for the user, which travel route is directed from the starting geographic location to the destination geographic location; (c) using the server to identify one or more transactional options for the user along the route; and (d) presenting the one or more transactional options on an electronic device while the user is travelling along a segment of the travel route in a terrestrial mass transit vehicle, and the one or more transactional options are determined based at least in part on one or more members selected from the group consisting of a social graph of the user, a transportation graph of the user, a visitation graph of the user, a purchase graph of the user, calendar data and to-do list data.

In some embodiments, the destination geographic location is automatically determined based on historical data related to the user. Alternatively, the destination geographic location may be determined based at least in part on a user input. Systems and methods herein may be capable of processing a varieties of user input and determine a destination geographic location accordingly. For example, a user may enter the destination declaratively, such as “I want to go to the Moscone Center”, or through a query, e.g., “How do I get to the Moscone Center?” In some cases, the geographic location may be determined based at least in part on the user's calendar data (e.g., “meeting with John at the Moscone Center”). In some embodiments, the starting geographic location is determined using a geographic location of the electronic device, which geographic location is determined by a global position system or signal triangulation. In some embodiments, the starting geographic location is entered by the user via a graphical user interface (GUI) on the electronic device. In some embodiments, the travel route and the one or more transactional options are generated using a machine learning algorithm. In some embodiments, the one or more transactional options are determined based at least in part on one or more members selected from the group consisting of a social graph of the user, a transportation graph of the user, a visitation graph of the user, a purchase graph of the user, calendar data and to-do list data. In some embodiments, the method further comprises determining a transportation mode for one or more portions of the travel route. In some cases, the transportation mode comprises autonomous personally owned vehicle, ride-hailing service or ride sharing service delivered using autonomous or human driven vehicle, rail transportation, and/or terrestrial mass transit vehicle. In some cases, a transportation mode determined for a first portion is different from a transportation mode determined from a second portion.

In some embodiments, the method further comprises receiving a user input indicating acceptance of at least one of the one or more transaction options and in response to receiving the user input, conducting at least one transaction option. In some embodiments, the method further comprises generating a new transaction option upon receiving a user input indicating a rejection of one of the one or more transaction options. In some embodiments, the transportation mode is selected from the group consisting of: an autonomous vehicle, a human-driven automated vehicle, a ride-hailing service, a ride-sharing service, rail transportation, a terrestrial mass transit vehicle, bicycle, and e-scooter

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

In another aspect, a method for facilitating commerce while a user is traveling along a route is provided. The method comprises: (a) at a server, receiving a starting geographic location and a destination geographic location of the user; (b) using the starting geographic location and the destination geographic location to generate the route for the user, which route is directed from the starting geographic location to the destination geographic location; (c) using the server to identify one or more transactional options for the user along the route; and (d) presenting the one or more transactional options on an electronic device of the user while the user is traveling along a segment of the route in a terrestrial vehicle, wherein the one or more transactional options are determined based at least in part on one or more members selected from the group consisting of a social graph of the user, a transportation graph of the user, a visitation graph of the user, a purchase graph of the user, calendar data and to-do list data.

In some embodiments, the destination geographic location is automatically determined based on historical data related to the user. In some embodiments, the starting geographic location is entered by the user via a graphical user interface (GUI) on the electronic device. In some embodiments, the route and the one or more transactional options are generated using a machine learning algorithm.

In some embodiments, the method further comprises determining a transportation mode for one or more segments of the route. In some cases, the transportation mode comprises autonomous vehicle, ride-hailing service, rail transportation, and/or terrestrial mass transit vehicle. In some instances, the transportation mode comprises a type of autonomous vehicle. In some embodiments, at least one of the one or more transaction options is to be conducted at a location connecting two consecutive segments of the route.

In another aspect, a method is provided for facilitating commerce while a user is traveling along a travel route. The method comprises: (a) at a server, receiving a starting geographic location and a destination geographic location of the user; (b) using the starting geographic location and the destination geographic location to generate the travel route for the user, which travel route is directed from the starting geographic location to the destination geographic location; (c) using the server to identify one or more transactional options for the user along the travel route; and (d) presenting the one or more transactional options on an electronic device of the user while the user is traveling along a segment of the travel route in an (1) autonomous vehicle or (2) a terrestrial mass transit vehicle.

In some embodiments, the destination geographic location is automatically determined based on historical data related to the user. In some embodiments, the starting geographic location is entered by the user via a graphical user interface (GUI) on the electronic device. In some embodiments, the travel route and the one or more transactional options are generated using a machine learning algorithm. In some embodiments, the one or more transactional options are determined based at least in part on one or more members selected from the group consisting of a social graph of the user, a transportation graph of the user, a visitation graph of the user, a purchase graph of the user, calendar data and to-do-list data.

In some embodiments, the method further comprises determining a transportation mode for one or more segments of the travel route. In some cases, the transportation mode comprises autonomous vehicle, ride-hailing service, rail transportation, and/or terrestrial mass transit vehicle. In some instances, the transportation mode comprises a type of autonomous vehicle. In some embodiments, at least one of the one or more transaction options is to be conducted at a location connecting two consecutive segments of the travel route. In some embodiments, the method further comprises repeating (b) and/or (c) upon detection of a change in the calendar data or to-do-list data associated with the user.

In another aspect, a method is provided for facilitating commerce while a user is traveling along a route. The method comprises: (a) at a server, receiving a starting geographic location and a destination geographic location of the user; (b) using the starting geographic location and the destination geographic location to generate the route for the user, which route is directed from the starting geographic location to the destination geographic location; (c) using the sever to extract contextual information associated with the destination geographic location; and (d) using the server to identify one or more transactional options for the user along the route based at least in part on the contextual information.

In some embodiments, the method further comprises, while the user is traveling in a terrestrial vehicle along at least a portion of the route, presenting the one or more transactional options to the user on an electronic device within the terrestrial vehicle. In some cases, the terrestrial is an autonomous vehicle. In some embodiments, the contextual information comprises an activity associated with the destination geographic location. In some embodiments, the one or more transactional options are determined based at least in part on a segment to which the user is assigned.

While various embodiments have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments described herein may be employed.

As used herein, the terms “autonomously controlled”, “self-driving”, “autonomous”, and “pilotless,” when used in describing a vehicle, generally refer to a vehicle that can itself perform all driving tasks and monitor driving environment along at least a portion of a route. An autonomous vehicle may travel from one point to another without any intervention from a human onboard the autonomous vehicle. In some cases, an autonomous vehicle may refer to a vehicle with capabilities as specified in the National Highway Traffic Safety Administration (NHTSA) definitions for vehicle automation, and specifically Level 4 of the NHTSA definitions, “an Automated Driving System (ADS) on the vehicle can itself perform all driving tasks and monitor the driving environment—essentially, do all the driving—in certain circumstances. The human need not pay attention in those circumstances,” or Level 5 of the NHTSA definitions, “an Automated Driving System (ADS) on the vehicle can do all the driving in all circumstances. The human occupants are just passengers and need never be involved in driving.” In some cases, an automated vehicle may refer to a vehicle with capabilities specified in the Level 2 of the NHTSA definitions, “an advanced driver assistance system (ADAS) on the vehicle can itself actually control both steering and braking/accelerating simultaneously under some circumstances. The human driver must continue to pay full attention (”monitor the driving environment“) at all times and perform the rest of the driving task,” or Level 3 of the NHTSA definitions, “an Automated Driving System (ADS) on the vehicle can itself perform all aspects of the driving task under some circumstances. In those circumstances, the human driver must be ready to take back control at any time when the ADS requests the human driver to do so. In all other circumstances, the human driver performs the driving task.” The automated vehicle may also include those with Level 2+automated driving capabilities where AI is used to improve upon Level 2 ADAS, while consistent driver control is still required.

The term “passenger vehicle,” as used herein, generally refers to a vehicle used for passengers, such as a car or a truck, but excluding mass transit vehicles.

The term “mass transit vehicle,” as used herein, generally refers to a multi-passenger vehicle, such as a train or a bus, which can transport a group or groups of passengers.

As used herein, the term “trip” generally refers to the total time and/or route(s) taken from a first location to a second location. A trip may include one or more routes. The term “route” generally refers to a set of one or more directions that permit a user to travel from the first location to the second location. A route can have one or more segments. A segment may refer to a part of portion of a route between an embarkation point and a disembarkation point.

The term “contextual information,” as used herein, generally refers to any information associated with a geographic location and/or an event. Contextual information may be derived from information indicative of or related to such geographic location and/or event.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The present disclosure provides methods and systems for generating personalized transportation plan. The methods and components can include those as described in Simoudis I.

### Methods and Systems for Facilitating Commerce Along a Route

The present disclosure provides systems and methods that may be capable of personalizing a consumer's transportation experience in and out of a vehicle. Systems and methods of the present disclosure may provide a platform for passenger commerce. Passenger commerce may include, for example, activities and services related to: a) subscriptions to access content, e.g., an annual subscription to a music streaming service, a news service, a concierge service, etc.; b) transaction-based purchase of goods, services, and content while being transported, as well as when vehicles intermittently stop, such as at refueling stations, restaurants, coffee shops, etc. (e.g., a recharging station operator, such as an energy company, can partner with a coffee shop chain to offer discounts in coffee drinks to passengers who purchase while refueling a vehicle); and c) redemption of loyalty points, e.g., automakers and fleet operators can reward their customers for their loyalty, using a system similar to that used by airlines or hotel chains where the loyalty points can be redeemed in much the same way these and other industries use such programs. For example, for every 5,000 ridesharing miles in a particular automaker's vehicles, the consumer receives points that are redeemed towards free cellular data to be used in their personal vehicle. Passenger commerce may comprise any type of in-cabin commerce, in-vehicle services or transactions which may be used or referred to interchangeably throughout the specification.

The system may provide concierge services in accordance with the personalized transportation experience. In an example, the system may automatically Create a list of candidate restaurants (e.g., the top 5 candidate restaurants) that based on the preferences of the individuals, and reservation availability at the time of interest, seating preferences based on the meeting's nature, and/or availability of parking with a charger for the individual's car; analyze historic traffic patterns for midweek rush hour traffic for the routes that go from start location to each of the candidate restaurants and determine that 60-75 minutes will be required for the commute to the restaurants; eliminate 2 of the 5 restaurants because the individual can only afford 60 minutes for the commute based on when the meeting at previous location (start location) ends.

The concierge service (e.g., server) may interface with the transportation service (e.g., via API) and propose to the individual the three identified restaurants. The individual may select one.

The concierge service may then proceed to make the reservation of the selected restaurant, requesting a quiet table (or a small private room based on the meeting's nature), block 60 minutes on her calendar to allow for the commute time, so no other in-person meetings will be scheduled, reserve a parking space and a charger at the parking lot nearby the restaurant where reservations were made, send driving directions to the individual's vehicle from the start location to the parking lot, send walking directions to the individual's phone from the parking lot to the restaurant, send driving directions to the individual's vehicle from the parking lot to the next location after the meeting (e.g., individual's house), and notify the participant of the meeting (e.g., time, restaurant name, location) and offer to make a reservation with a ride-hailing service to take him from his hotel to the restaurant.

During the ride to the restaurant, the concierge service may be notified by the system regarding the traffic condition (e.g., there is heavier than anticipated traffic). As a result, the arrival time to the chosen restaurant may be delayed by 15 minutes. Based on this information, the concierge service may notify the restaurant of the delay, notify the participant of the delay, change the participant's ride-hailing pick up time from his hotel.

The platform may be capable of generating a personalized transportation plan for a user, to process, recommend, and/or present personalized mobility data, routing data, scheduling data, traffic data, and many other forms of data. In some instances, machine learning techniques can be utilized to create a personalized transportation plan that includes predicted destinations, travel schedules (e.g., begin time, end time), options for transaction-based purchase of goods, services, and content during transportation, types of vehicles (e.g., types of autonomous vehicles such as sedans or vans, brands), types of transportation modes (e.g., autonomous vehicle, public transportation (such as train, light rail, or city bus), shuttle, ride-sharing, ride-hailing, shared trip or private trip, walking, bicycle, e-scooter, taxi, etc.), and others. In particular, the personalized transportation plan may be generated based on various types of data and/or a variety of sources of data, including, but not limited to, social graphs/networks/media, purchase graphs, transportation graphs, demographic information, mobile applications (e.g., calendar, to-do list, weather, vendor or service provider catalogs, etc.), and various others. The data used to generate the transportation plan may include both historical data (e.g., user preferences, transportation history, purchase history, etc.) and plan data (e.g., to-do list data, calendar data, electronic mail data, etc.).

Artificial intelligence, such as machine learning algorithms, may be used to train a predictive model for producing a personalized transportation plan. A machine learning algorithm may be a neural network, for example. Examples of neural networks include a deep neural network, convolutional neural network (CNN), and recurrent neural network (RNN). In some cases, a machine learning algorithm trained model may be pre-trained and implemented on the vehicle system, and the pre-trained model may undergo continual re-training that involves continual tuning of the predictive model or a component of the predictive model (e.g., classifier) to adapt to changes in the implementation environment over time (e.g., changes in the customer/user data, vehicle data, model performance, third-party data, etc.).

A user may be pre-registered with the system or subscribed to one or more mobility services provided by the system. A user may be a prospective requestor for a mobility service. A user may utilize a user mobile application to plan a trip from an origin location to a destination location. The application can provide one or more transactional services or passenger commerce options to the user. A user may access services or conduct transactions during the trip via the application. A user may be transported from a first location to a second location with the use of, and/or while having access to, one or more services including mobility services and user experience services provided by the system during the trip. A user may be a driver or a passenger of a vehicle. The user can be any person who is traveling in a vehicle and is subscribed to one or more mobility services provided by the system. In some cases, a user may subscribe to the one or more mobility services as the user is traveling in the vehicle and need not be subscribed to the mobility service(s) prior to traveling in the vehicle. In other cases, a user may have already subscribed to the one or more mobility services prior to traveling in the vehicle. A user may, at any time, subscribe to one or more additional mobility services, or modify/change an existing subscription.

The vehicle can have various numbers of users. The vehicle can have at least 1, 2, 3, 4, 5, 6, 7, 8, 9, 10 or more users. For example, the vehicle may include a driver and a passenger. In some cases, the vehicle may include only passenger(s) and need not have a human driver.

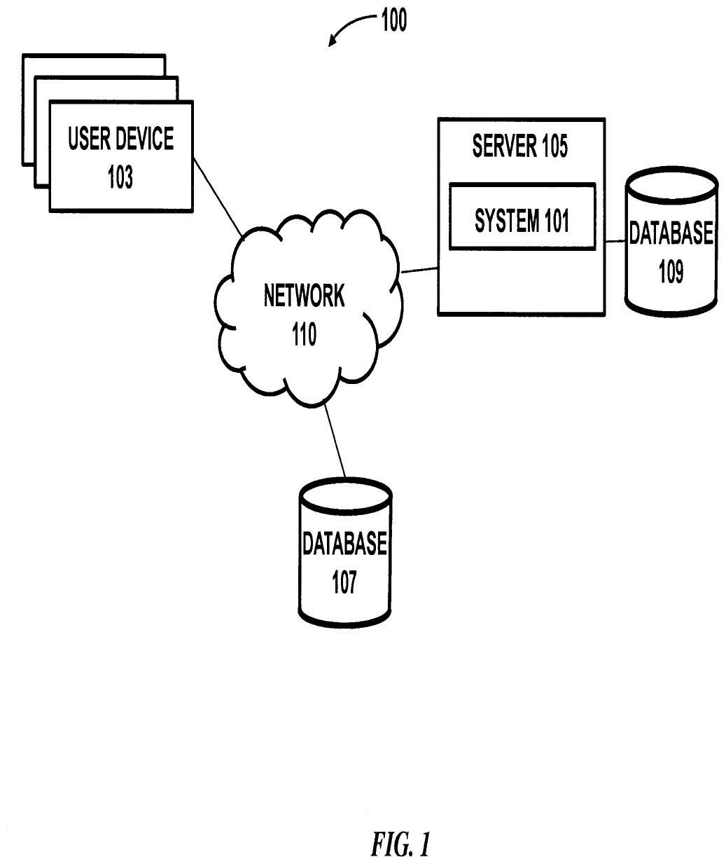

FIG. 1 schematically illustrates an example of a network environment 100 in which a personal transportation management system 101 may be operated. The personal transportation management system 101 may interact with a plurality of user devices 103 through one or more networks 110. The personal transportation management system 101 may be a personal transportation platform for providing a personalized transportation experience including offering personalized services/products during the travel. In some embodiments, a user device of the plurality of user devices 103 may be a device associated with a user. In some embodiments, a user device may be used by a plurality of users. For example, a user device may be a built-in device or system inside or coupled to a vehicle. In some embodiments, two or more user devices may be associated with a single user.

In some embodiments, the personal transportation management system 101 may be configured to provide a user interface for a user to view a travel route and interact with one or more transactional options during a trip via a user device 103. The personal transportation management system may be configured to generate a personalized transportation plan including a travel route, schedule of departure time and arrival time of one or more segments or at one or more stops during the travel, transportation mode (e.g., type of transportation, type/brand of vehicles, configuration of a vehicle, etc.) for a segment of the travel route, and one or more services or passenger commerce (e.g., digital service, transactional events or business activities) during the travel. In some instances, the personalized transportation plan may also include transporting the user through at least one segment using an autonomous vehicle.

The personalized transportation plan may be generated based on data related to the user and/or data related to transactional services. The data related to the user may include historical data such as user preferences, transportation history, purchase history of goods and services, and plan data such as to-do list data and calendar data. Such data may be collected from a variety of data sources such as mobile applications (e.g., calendar app, to-do list app, email, text messages, map, social network app, personal health apps, etc.), social network software, third-party service providers such as mobility service providers (e.g., Uber® and Lyft®), vendors, business entities (e.g., fast food, restaurants, coffee shops, hospitality, convenience stores, refueling stations, theaters, etc.), content providers (e.g., Apple Music®, video, games, etc.), digital virtual assistant, smart home device such as Alexa®, interactive voice response (IVR) systems, social media channel and messenger APIs such as Facebook® channel, Twilio SMS channel, Skype® channel, and various other sources. Data related to transactional services may include a rejection or acceptance of a prior transactional service by the user or data from third-party service providers. The personalized transportation plan can be generated using a machine learning based model. The input data may be data derived from the varieties of data as described above. For instance, the input data may include social graph/networks, purchase graph, transportation graph, demographic information, weather data, vendor or service provider catalogs and various others. The output of the model may be a travel route, schedule of one or more segments of the travel route (e.g., departure time, arrival time, etc.), a transportation mode for each segment (e.g., vehicles, types of a car), and one or more transactional options or services during the travel. In some cases, a transactional offer may be provided by the system in real-time. For example, upon receiving a user input indicative of rejection on a service offer, a new transactional offer may be selected and provided to the user in real-time. Details about generating a personalized transportation plan are described elsewhere herein.

Real-time, as used herein, generally refers to a response time that does not appear to be of substantial delay to a user as graphical elements are pushed to the user via a user interface. In some embodiments, a response time may be associated with processing of data, such as by a computer processor, and may be less than 2 seconds, 1 second, tenth of a second, hundredth of a second, a millisecond, or less. Real-time can also refer to a simultaneous or substantially simultaneous occurrence of a first event with respect to occurrence of a second event.

The personal transportation management system 101 may comprise one or more servers 105 and one or more database systems 107, 109, which may be configured for storing or retrieving relevant data. Relevant data may comprise the user profile data (e.g., user preferences, personal data such as identity, age, gender, contact information, demographic data, ratings, etc.), historical data (e.g., social graph, transportation history, transportation subscription plan data, purchase or transaction history, loyalty programs, plan data such as calendar data and to-do list, etc.) and various other data as described elsewhere herein. In some cases, the relevant data may comprise map information that is used to plan a route or calculate estimated time of departure/arrival. In some cases, the personal transportation management system may source data or otherwise communicate (e.g., via the one or more networks 110) with one or more external systems or data sources, such as one or more map, weather, or traffic application program interface (API) or map database. In some instances, the personal transportation management system may retrieve data from the database systems 107, 109 which are in communication with the one or more external systems (e.g., mobility service providers, autonomous vehicle dispatching system, third-party passenger commerce entities such as fast food, restaurants, coffee shops, hospitality, convenience stores, refueling stations, theaters, digital service providers, etc.). In some cases, the database may be a synchronization database that maintains tables or records for information such as weather, traffic, public transit, Global Positioning System (GPS) input or logs, planning data, personal data and other data obtained from external data sources.

Each of the components (e.g., servers, database systems, user devices, external systems, and the like) may be operatively connected to one another via one or more networks 110 or any type of communication links that allows transmission of data from one component to another. For example, the respective hardware components may comprise network adaptors allowing unidirectional and/or bidirectional communication with one or more networks. For instance, the servers and database systems may be in communication—via the one or more networks 110—with the user devices 103 and/or data sources to transmit and/or receive relevant data.

A server (e.g., servers 105) may include a web server, a mobile application server, an enterprise server, or any other type of computer server, and can be computer programmed to accept requests (e.g., HTTP, or other protocols that can initiate data transmission) from a computing device (e.g., user device, other servers) and to serve the computing device with requested data. A server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In addition, a server can be a broadcasting facility, such as free-to-air, cable, satellite, and other broadcasting facility, for distributing data. A server may also be a server in a data network (e.g., a cloud computing network).

A server may include various computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general-purpose computers.

The one or more databases 107, 109 may utilize any suitable database techniques. For instance, structured query language (SQL) or “NoSQL” database may be utilized for storing the user profile data, historical data, predictive model or algorithms used for generating a personalized transportation plan, map or other data. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionalities encapsulated within a given object. In some embodiments, the database may include a graph database that uses graph structures for semantic queries with nodes, edges and properties to represent and store data. If the database of the present disclosure is implemented as a data structure, the use of the database of the present disclosure may be integrated into another component such as the component of the present disclosure. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

In some embodiments, the personal transportation management system 101 may construct the database in order to deliver the data to the users or care providers efficiently. For example, the personal transportation management system 101 may provide customized algorithms to extract, transform, and load (ETL) the data. In some embodiments, the personal transportation management system 101 may construct the databases using proprietary database architecture or data structures to provide an efficient database model that is adapted to large-scale databases, is easily scalable, is efficient in query and data retrieval, or has reduced memory requirements in comparison to using other data structures. For example, a transportation graph may be stored using a graph data structure with nodes and links presenting relationships between users, relationships between a user and a location, and relationship between locations.

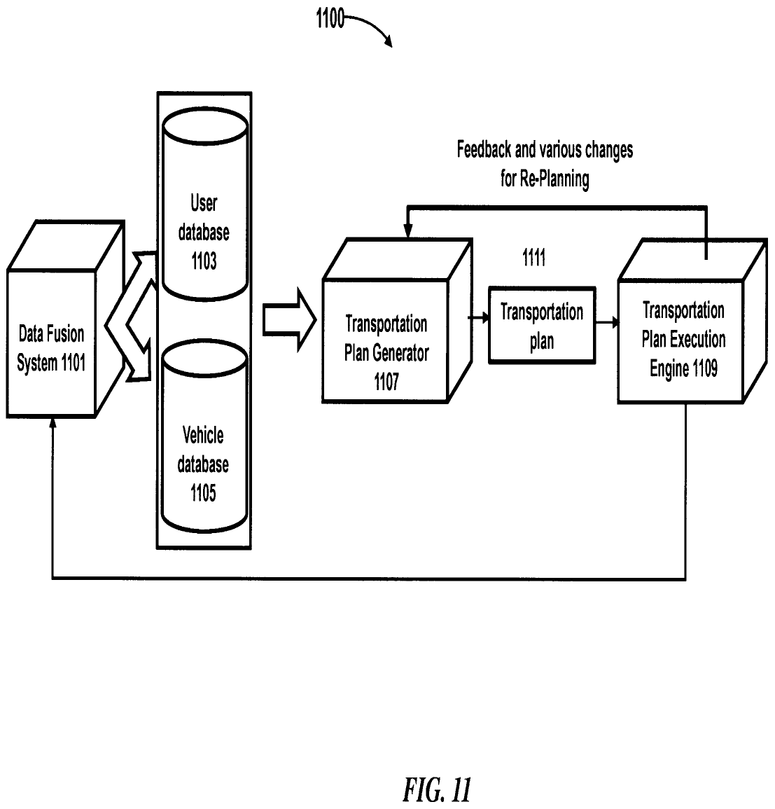

FIG. 11 shows an example of a personal transportation management system 1100. In some cases, the personal transportation management system 1100 may comprise a data fusion system 1101, a user database 1103, a vehicle database 1105, a transportation plan generator 1107 and a transportation plan execution engine 1109.

The data fusion system 1101 may be configured to import and fuse data from a variety of sources to generate or update a profile of a user, and generate or update a profile of a vehicle that is either owned by the user, or a fleet's operator. The fused data may be incorporated into the user database or the vehicle database. The data fusion system 1101 may be configured to pre-process the data using suitable functions. For instance, the plurality of functions for data processing may comprise ingestion, filtering, cleaning, tagging, augmentation, annotation, anonymization, and various others (e.g., simulate). The data fusion system may prepare the data such that it can quickly and easily be accessed via APIs by intended data consumers or applications. In another example, the data fusion system may combine traffic data with purchase data to predict travel time for a fleet pertaining to a user, combine several data sets to create information-rich data, (e.g., combine vehicle operating data, with city transportation infrastructure data, and congestion data to predict vehicle arrival times during specific times of the day). The data fusion system 1101 may comprise an extract-transform-load (ETL) system. The ETL system may perform traditional ETL functionalities or customized functionalities. For instance, the ETL system may transform the ingested batch data or stream data to a format more useful to a user. For example, the data transformation may include selecting only certain columns to load into a format, translating coded values, deriving new calculated values, sorting data, aggregating data, transposing or pivoting data, splitting a column into multiple columns, and other processing.

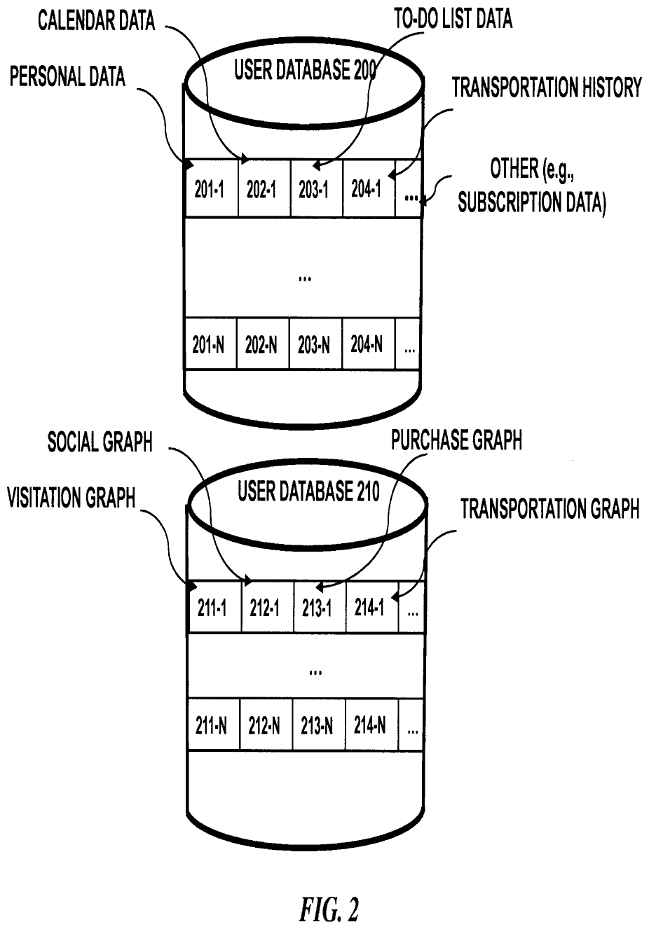

The user database 1103 may manage data related to a user or a user profile. Details about the user database are described in connection with FIG. 2

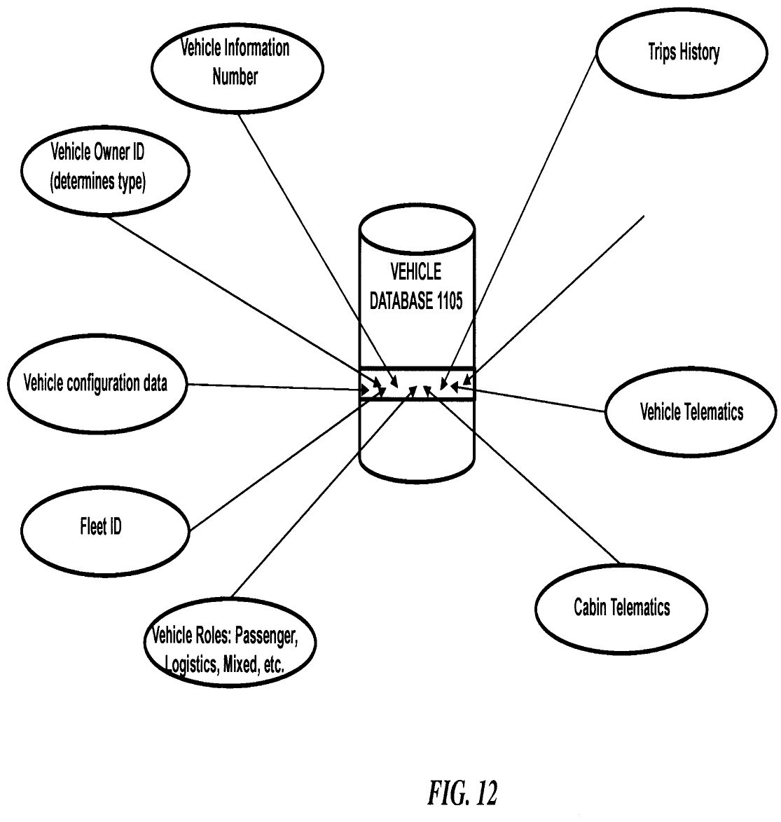

The vehicle database 1105 may be configured to manage the data that is related to a vehicle profile (Privately-Owned, Corporate Fleet-Owned) for each vehicle participating in a given service. FIG. 12 shows examples of data stored in a vehicle database. In these examples, data, such as vehicle owner ID, trips history, vehicle information, vehicle configuration data, fleet ID, vehicle roles (e.g., passenger, logistics, mixed, etc.), cabin telematics, vehicle telematics, maintenance history and various other data, may be managed and stored in the vehicle database.

The transportation plan generator 1107 may be configured to generate personalized transportation plan 1111 based on data retrieved from the user database and vehicle database. The transportation plan generator may also be referred to as transportation plan creator or transportation plan step creator which are used interchangeably throughout this specification.

In some cases, the transportation plan generator 1107 may comprise a trip creator 1107-1 that is configured to create a trip by synthesizing a plurality of location points. The plurality of location points may include, for example, location of the trip origin, location of the trip destination (e.g., trip end location), and the location(s) of intermediate point(s). The intermediate points can be obtained from the passenger's device, the driver's device, or the vehicle system. These location points may be used to synthesize a route or the entire trip. In some cases, user-defined and/or publicly available Points of Interest (POIs) that are encountered during the trip may be marked in the synthesized trip which may be used as decision-making points to determine what transactional options to be provided to the passenger. In some cases, the transportation plan generator may use a consumer/subscriber ID and associated location points (e.g., latitude/longitude) and automatically create a time series of trips for the consumer/subscriber ID.

In some cases, the input to the transportation plan generator may include a user input indicative of a goal (e.g., “I want to go grocery shopping”) along with any additional constraints (e.g., “I need to be back home within 30 minutes”). In some cases, the transportation plan generator may further retrieve data from the knowledge base to generate a plan. A plan may comprise a set of actions to accomplish the goal while satisfying the constraint. For example, a plan may include elements such as getting in the car, turning on the engine, driving down this particular route, arriving at the grocery store, and the like. The knowledge base provides a plethora of information about a specific subject matter in multiple data sources that can be accessed from global locations with Internet access, or other relevant technologies. The knowledge base may be manually encoded or automatically learned. In some cases, the transportation plan generator may apply logical rules to the knowledge base to deduce new knowledge.

The system may determine a type of a route taken in a trip. For example, a characteristic of a route type may include but not limited to, direct/indirect, fast/slow, cheap/expensive, fuel-efficient/non-eco-friendly, monomodal/multimodal, urban/rural, familiar/new and various others. In some cases, the system may comprise one or more rules for generating a route-type and may assign one or more tags to the route. For example, in order to satisfy the Traveler's constraint for completing the trip to the supermarket within 30 minutes and returning home within such a period, the planner will use its knowledge base and access the database of prior trips to identify a route that is tagged as direct, fast, cheap (e.g., no tolls), fuel-efficient, monomodal, urban, and familiar.

In some cases, a trip may be described using one or more characteristics. The one or more characteristics for characterizing or describing a trip may include, for example, trip intent (e.g., grocery shopping), venue (e.g., supermarket), route-type (e.g., direct, fast, cheap, fuel-efficient, monomodal, urban, and familiar) and/or modality (e.g., privately owned vehicle (POV)).

In some cases, the methods herein may implement object-oriented system where data is represented as discrete objects. For instance, the characteristics of a trip of a Traveler may be coded in a structured data structure. For example, the characteristics of a trip may be stored in a matrix where each row corresponds to a trip, and each column describes a characteristic of the trip (e.g., Grocery-shopping-intent, Super-market-venue, Direct-route, Indirect-route, etc.). As an example, an entry in the matrix/table may be 0 or 1 denoting whether a given characteristic was present in the trip being described. Each traveler may have a trip matrix. Alternatively, trips of multiple Travelers may be stored in a single matrix. The structured data object may allow for efficient computation. For example, similar trips may be identified by comparing matrices (e.g., comparing the characteristics of the new/current trip and the past trips) via a matrix operation.

In some embodiments, the transportation plan generator 1107 may be capable of automatically identifying or characterizing a trip type (e.g., commute to work, business travel, daily trip, vacation trip, shopping trip, trip to the airport, etc.), identifying or characterizing a user type (e.g., driver, passenger, service driver such as a driver of a ride-hailing service, etc.) or identifying the POIs at the origin, destination, and at any point or location during the trip.

The transportation plan generator 1107 may comprise a trip classifier 1107-3 that is configured to predict the type of the next trip based on data retrieved from the user database and vehicle database. The type of trip may be predicted using a trained predictive model (e.g., support vector machine or neural network). In some case, the type of trip may be predicted based at least in part on a segment to which the user is assigned (which is described in the following paragraph). In some cases, the predictive model may be a machine learning algorithm trained model that can be pre-trained and implemented on the vehicle system, and the pre-trained model may undergo continual re-training that involves continual tuning of the predictive model or a component of the predictive model (e.g., classifier) to adapt to changes in the implementation environment over time (e.g., changes in the customer/user data, vehicle data, model performance, third-party data, etc.).

The transportation plan generator 1107 may comprise a user/customer segmentation module 1107-2. The customer segmentation may allow the system to target a certain segment of the subscribers to make offers that may be relevant (e.g., found to be most relevant) to those subscribers. The subscribers or users may be segmented (or organized into one or more segments) using any suitable segmentation technique. For example, the segmentation technique may be based on fixed rule sets. Subscribers may be grouped based on geography (or geolocation), social graph(s), purchase graph(s), transportation graph(s), demographic information, user preference(s), installed mobile application(s), or other user attribute(s) or characteristic(s) extracted from the user profile data, as described above. Subscribers in the same group may share one or more user attributes or subscriber characteristics (e.g., age, gender, geolocation, social graph, frequent flyer, frequent food shopper, etc.). An individual may belong to one or more segments. In some cases, the segments may be continuously augmented and updated automatically as new data is collected. In some embodiments, new segments may be created as new users (or classes of users) are added to or subscribed to the system. In some cases, the segments may be discrete. In other cases, two or segments may overlap, and may share a set of commonalities or characteristics.

In some cases, the segmentation technique may be based on a pattern extracted from historical data (e.g., user profile data). The pattern may be extracted using a machine learning algorithm. In some cases, a set of patterns may be initially generated and an algorithm may be employed to identify an optimal allocation of patterns to segments that is both feasible and maximize a desired outcome. The desired outcome may be offering a small number of in-vehicle service or transaction options to be sent to appropriately chosen customers (e.g., group of customers) at the appropriate time and/or location such that the chosen customers are likeliest to accept the in-vehicle service. The initial set of patterns may be generated using any suitable method such as a decision tree or other pattern identification algorithm. In some cases, the algorithm for identifying an optimal allocation of patterns to segments may be a trained machine learning algorithm (e.g., support vector machine or neural network).

The algorithms for generating the transportation plan may be applied to various other applications. For example, the algorithms for predicting the POIs, destinations, trip intents, customer segmentation and the like may be used for providing personalized recommendations, or predicting a customer's next steps (e.g., stops or transactions they may like to make). For instance, algorithms herein may be further used for identifying potential opportunities to improve the monetization of a predicted route, and/or for providing additional places for a traveler to stop on route to their destination. Unlike traditional personalization recommendation which is tailored to a segment or a group of consumers sharing similar traits rather than truly individualized personalization, the artificial intelligence (AI) recommendation engine/algorithm herein may be capable of generating personalized recommendations that are unique to each consumer/user by leveraging the knowledge extracted from each unique individual and trips associated with each individual. Additionally, the AI recommendation engine/algorithm may be capable of accurately predicting what the consumers will engage with in the future.

In some embodiments, the personalized recommendation might operate as a set of process steps stored in computer memory that might generate one or more POIs or recommended waypoints for an individual consumer. The waypoints might be stored in a data structure referred to as an EnhancedWaypoints data structure herein. The recommended waypoints might or might not be along an original route predicted by the system. In some cases, the recommended waypoints may include recommended activities, transactions and like to be performed at a location not along the original predicted route. For example, the method or system herein may first determine an optimal route based on mandate waypoints (e.g., locations must travel, destination, etc.) and the user profile (e.g., the characteristics of routes taken for each particular intent, route conditions, etc.), then apply an EnhancedWaypoints algorithm to identify the additional waypoints on the optimal route or deviate from the optimal route as recommended waypoints. Alternatively, the process for adding enhanced waypoints may be applied to all the routes (all the candidate routes) generated by the route generator such that each route is incorporated with one or more recommended waypoints, then identify the optimal route taking into account the recommended waypoints incorporated in each route.

The enhanced or recommended waypoints may be generated for a new route or route for a new trip to be taken. The enhanced or recommended waypoints may be generated by associating the insights about each trip's intent (e.g., predicted or state intent) with historical data about the route that was taken and the transportation modalities that were used in past trips. For instance, the system may derive insights about the intent of a trip taking into account venue preferences (e.g., a supermarket for grocery shopping) and associating venue preferences with route preferences and modality preferences. For example, the system may predict an intent of a trip is grocery shopping where the trip originated from the Traveler's home (e.g., a specific address), ended in supermarket, and the traveler used their personal vehicle and traveled on a specific route involving specific streets. In some cases, a partial intent may be provided by a user. For example, a user may provide an input indicating grocery shopping (e.g., “find locations for grocery shopping”) and the system may automatically complete the intent (e.g., destination, geolocation of grocery markets) based on the user-provided partial intent. The partial intent may be related to a location, an activity, a service, time, dates, availability of a service, and the like and the system may be capable of generating recommendations and trips based on the partial intent.

In some cases, a recommendation for one or more Enhanced Waypoints or recommended waypoints to be incorporated in a route (that is recommended for a new trip) may be generated based on characteristics comprising traveler characteristics (e.g., user segmentation), traveler (routes) preferences, modalities, trip intents, travel context as defined by weather, traffic conditions and the like. The recommendation for one or more Enhanced Waypoints or recommended waypoints may be generated using one or more rules.

In some cases, the recommendation algorithm may comprise a variety of API calls/functions. For example, the transportation plan generator 1107 may call the function Enhanced_Waypoints (TripObject, TravelerObject, TravelerWaypoints) that returns the EnhancedWaypoints (POIs) and call the function Recommended_Waypoints (TripObject, TravelerObject) to generate recommended waypoints.

As an example, the Enhanced_Waypoints algorithm may: 1) generate the possible routes through which the Traveler can visit all the TravelerWaypoints. The TravelerWaypoints may be MandatoryWaypoints; 2) Define RouteModalitySet=(Generate_RouteModality_Set Trip.Origin (TripObject) Trip.Destination (TripObject) TravelerWaypoints) and label each route in the RouteModalitySet such as direct, urban, fast by calling function CategorizedRouteModalitySet=(Categorize_Routes RouteModalitySet); 3) automatically select the best route from the identified routes for the particular Traveler based on the preferences expressed in TravelerProfile by calling function SelectedRoute=(Select_Route Traveler.Profile (TravelerObject)) CategorizedRouteModalitySet); 4) generate EnhancedWaypoints which includes an ordered list of waypoints by calling the function EnhancedWaypoints=(Union (Recommended_Waypoints TripObject TravelerObject) TravelerWaypoints). In some cases, in the process of creating the EnhancedWaypoints some of the waypoints of Type=Optional from the TravelerWaypoints may be dropped because they cannot be accommodated due to constraints. The points may be dropped based on one or more conflict resolution rules. For example, if there is traffic congestion that does not allow the user to pick up flowers and pick up the child from school at the specific time the child needs to be picked up, then the pickup flowers waypoint is dropped; 5) RETURN (Match_POI_to_Waypoints EnhancedWaypoints)

The system may also provide recommended waypoints by calling the Recommended_Waypoints (TripObject, TravelerObject) function. As an example, without limitation, the algorithm may comprise:

### 1) EstablishedGeofence=(Select_Geofence Trip.Selected_Route (TripObject));

### 2) SelectedTrips=(Select_Relevant_Trips (TripObject, TravelerObject));

### 3) IF SelectedTrips=NIL

```
THEN
  RecommendedWaypoints =
    (Propose_POIs ((Trip.Selected_Route (AnyTrip)),
    EstablishedGeofence))
ELSE
    RecommendedWaypoints =
      (Find_All _Recommended_Waypoints (SelectedTrips))
RETURN RecommendedWaypoints
```

A person of ordinary skill in the art would understand the definition of the functions and function calls described herein. For example, in the aforementioned step 1) the function Select_Geofence is called and is passed one parameter. The value of this parameter is obtained by getting the value of the attribute Selected_Route for the object instance called TripObject. Selected_Route is one of the attributes of the object called Trip.

The function for selecting the relevant trips i.e., Select_Relevant_Trips (AnyTrip, AnyTraveler) may be defined as:

```
For EachTrip in TripsDB
  IF
    (AND
    Trip.Intent (EachTrip) = Trip.Intent (AnyTrip)
    Trip.Duration (EachTrip) = Trip.Duration (AnyTrip)
    Trip.Distance (EachTrip) = Trip.Distance (AnyTrip)
    Trip.Modality (EachTrip) = Trip.Modality (AnyTrip)
    (Similar_Profile
      Traveler.Profile (EachTrip.Traveler),
      Traveler.Profile (AnyTraveler)) = YES
      (Similar_Route_Types
        (Route.Types Trip.Selected_Route (EachTrip),
        (Route.Types Trip.Selected_Route (AnyTrip)) = YES
    )
  THEN
    Insert EachTrip in TripsList
RETURN TripsList
```

The function Select_Geofence (AnyRoute) may comprise receiving the longitude/latitude pairs (e.g., from a user input indicating a user interested location) that defines the geofence around each of the routes to generated by the system. The location input may be in the form of coordinates that is obtained from a user input such as a selection on a digital map or in any suitable manner.

The function Find_All_Recommended_Waypoints (TripsList) may be defined as:

1. FOR EachTrip in TripsList
2. (Insert-Unique Trip.Added_Waypoints (EachTrip), WaypointsList)
3. RETURN WaypointsList

The function Insert-Unique (Element, List) may be defined as:

1. IF Member (Element, List) = NIL
THEN Insert (Element, List)
2. RETURN List

The function Propose_POIs (AnyTrip, AnyGeofence) may be a rule-based function where every rule considers the intent and the route types of of AnyTrip to propose POIs within AnyGeofence. For example, the function may be defined as:

```
(Rule
  IF Trip.Intent (AnyTrip) = “GroceryShopping”
  AND Route.Type (Trip.Selected_Route (AnyTrip)) = “Direct”
  AND Date.Type (Trip.Date (AnyTrip)) = “Weekend”
  AND Trip.Start_Time (AnyTrip) >= 8:00am AND <=12:00pm
  AND ReturnedPOI = (Find_POI AnyGeofence “CoffeeShop”)
  NOT NIL
  THEN RETURN ReturnedPOI
)
```

The system and methods herein may provide various other functions. For example, function Categorize_Waypoints (TravelerWaypoints) returns CategorizedWaypoints which is a list where every waypoint in the TravelerWaypoints is assigned a category. Examples of categories of waypoints may include Mandatory Waypoints (e.g., pick up child from school), Optional Waypoints (e.g., pick up flowers on the commute from work to home), and/or Calendar Waypoints (e.g., meet Joe at 3:00 pm at Location_1). The above categories can be further subcategorized into one or more subcategories. For example, Calendar Waypoints may have additional subcategories such as Team_Meeting, Business_Meal, etc. Function Recommended_Waypoints (OriginPOI, DestinationPOI, TravelerProfile, CategorizedWaypoints) returns the RecommendedWaypoints which is a list of categorized waypoints that are recommended based on the TravelerProfile that is stored in the TravelerDB (e.g., user database 1103). Some of the waypoints in this list may be mandatory. For example, if the system is able to access data that the car is low on gas (or low on charge in the case of electric vehicles) the system may automatically add a mandatory waypoint to pick up gas at a specific location. Function Merge_Waypoints (CategorizedWaypoints, RecommendedWaypoints) returns the EnhancedWaypoints which is an ordered list of waypoints. In some cases, creating the EnhancedWaypoints may comprise dropping some of the waypoints of Type=Optional from the TravelerWaypoints due to constraints. For example, if there is traffic congestion that does not allow the user to pick up flowers and pick up the child from school at the specific time the child needs to be picked up, then the pickup flowers waypoint is dropped. In some cases, based on the API availability the system may provide optional API calls such as Determine_Traffic_Conditions (Origin, Destination) which uses real-time traffic data, Determine_Public_Transport_Conditions (Origin, Destination) which uses real-time data to determine public transportation system delays, Determine_MS_Status (Origin, Destination), Vehicle_Status when privately owned vehicle (POV) is being used, and/or Traveler_Calendar function when permission is given and the calendar data is available.

It should be noted that the above functions and algorithms are for illustration purpose only and are not intended to be limiting. A person of ordinary skill in the art will recognize many variations based on the teaching described herein.

A transportation plan is executed by a transportation plan execution engine 1109. The personal transportation management system 1100 may be capable of updating a transportation plan automatically. For instance, the transportation plan execution engine may look for updates of data prior to execution of a transportation plan. As an example, upon detection of a new calendar entry is added, an existing calendar entry is modified, or a new task is added to the to-do list, the personal transportation management system 1100 may re-create and update the transportation plan. Once a plan is executed, the new data that is created as a result may be updated in the user database and/or the vehicle database. In some cases, the transportation plan execution engine may be configured to be in communication with suitable entities (e.g., third-party systems) to execute a transportation plan.

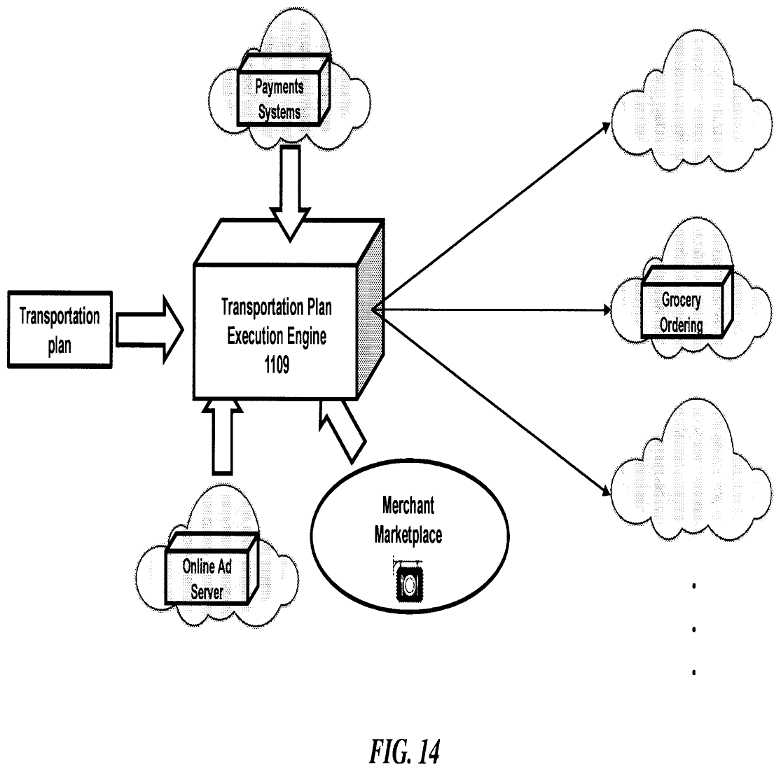

FIG. 14 shows an example of a transportation plan execution engine 1109. In some cases, the provided system may maintain a list of partners (e.g., Merchant Marketplace). When the transportation plan generator determines what transactional offers to include in a given plan, the transportation plan generator may access the list of partners. The list of partners (e.g., Merchant Marketplace) may also be used by the transportation plan execution engine to determine which external systems to access based on the transportation plan that is generated by the transportation plan generator. As illustrated in the example, the transportation plan execution engine may utilize machine learning techniques in the process of executing a user's daily plan. During the execution, the transportation plan execution engine may interface with the Merchant Marketplace, the systems of each partner in the Merchant Marketplace such as TNC reservation systems, restaurant reservation systems, grocery ordering systems, an online advertising server, or a payment system.

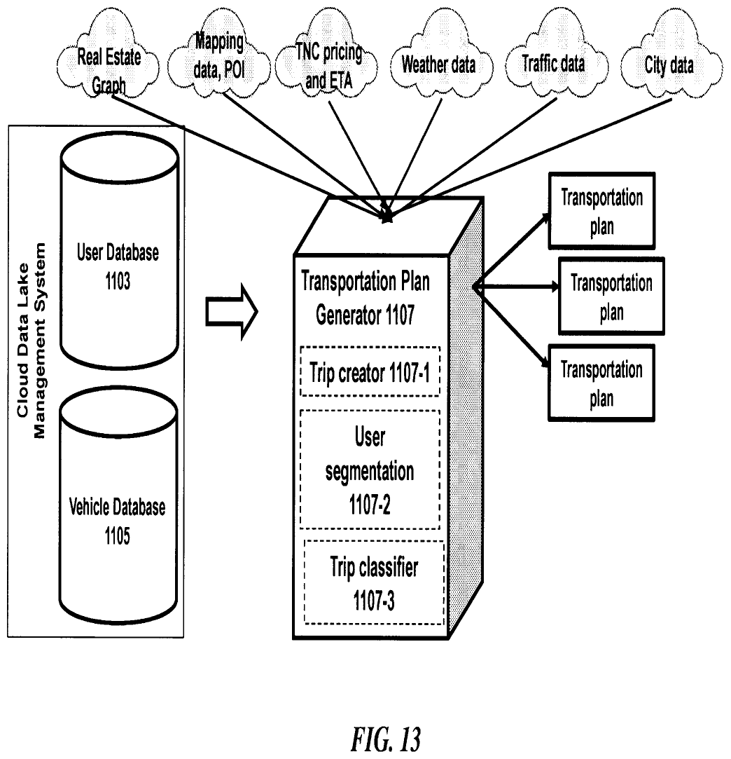

FIG. 13 shows examples of data processed or used by the transportation plan generator 1107. The transportation plan generator may be configured to analyze user data, vehicle data (e.g., data stored in the vehicle database or real-time vehicle data), and third-party data, and use machine learning, planning, and reasoning algorithms to create a transportation plan that is tailored to each user on a day-by-day basis, and updated as necessary in near real-time during the day. The various data used by the transportation plan generator are described with respect to FIG. 2, FIG. 11 and FIG. 12. For example, the data may include real-estate graph, mapping data, TNC pricing and ETA data, weather data, traffic data, city data and various others.

The user database and/or the vehicle database can be accessed by a variety of applications or entities that may be related to transactions, though in some situations some of the applications or entities may not be related to transactions.

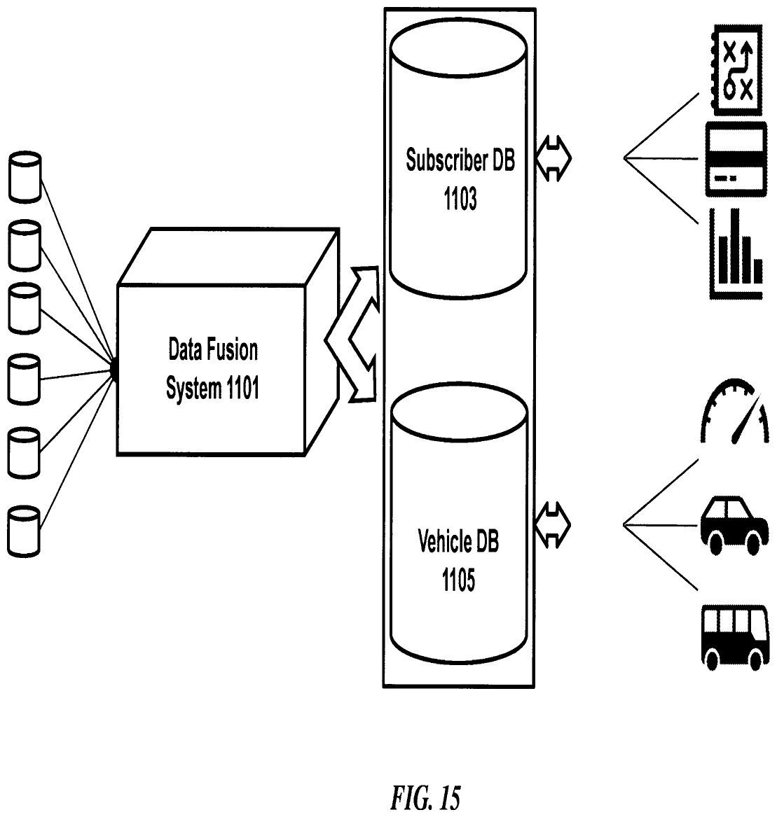

FIG. 15 illustrates an example of the data stored in the user database and vehicle database accessed by various applications. In some cases, data stored in the user database and/or vehicle database can be utilized or accessed by other applications through APIs (application programming interfaces). The data accessed by the variety of applications may include data generated by the transportation plan generator (e.g., Personal Daily Plans) and/or data collected from the vehicles or user devices. For example, the system may be in communication with a Fleet Coordination Application that uses the collection of plans created by the transportation plan generator during each particular day to coordinate and manage the fleet of vehicles that are controlled by the fleet operator. By accessing that data, the fleet operator may better coordinate and manage the vehicles that are available for use each day, thus achieving better per vehicle economics and higher subscriber satisfaction with the overall transportation service. Access to the database may be authorized at per API level, per data level (e.g., type of data), per application level or according to other authorization policies.

The personal transportation management system 101 may be implemented anywhere in the network. The personal transportation management system 101 may be implemented on one or more servers in the network, in one or more databases in the network, one or more electronic devices built in or coupled to a vehicle, or one or more user devices. For example, the personal transportation management system 101 may be implemented in a distributed architecture (e.g., a plurality of devices collectively performing together to implement or otherwise execute the personal transportation management system 101 or its operations) or in a duplicate manner (e.g., a plurality of devices each implementing or otherwise executing the personal transportation management system 101 or its operations as a standalone system). The personal transportation management system 101 may be implemented using software, hardware, or a combination of software and hardware in one or more of the above-mentioned components within the network environment 100.

A user device of the plurality of user devices 103 may be an electronic device. The user device may be a computing device configured to perform one or more operations consistent with the disclosed embodiments. Examples of user devices may include, but are not limited to, mobile devices, smartphones/cellphones, tablets, personal digital assistants (PDAs), smart wearable devices, smart watches, laptop or notebook computers, desktop computers, media content players, television sets, video gaming station/system, virtual reality systems, augmented reality systems, microphones, or any electronic device configured to enable the user to view the travel route, and interact with the transaction or service related information, and display other information as it relates to the travel, for example. The user device may be a handheld object. The user device may be portable. The user device may be carried by a human user. In some cases, the user device may be located remotely from a human user, and the user can control the user device using wireless and/or wired communications. The user device may be a computing device in communication with a wearable device worn by a user. In some cases, the wearable device may be configured to monitor user activities, vital signs (e.g., blood pressure and heart rate) or health conditions of a user. In some cases, the user device may be an electronic device coupled to or located on-board a vehicle.

In some embodiments, the user device may be capable of detecting a location of the device/user. The user device may have one or more sensors on-board the device to provide instantaneous positional or location information of the user device. In some embodiments, the instantaneous location information may be provided by sensors such as a location sensor (e.g., Global Positioning System (GPS)), inertial sensors (e.g., accelerometers, gyroscopes, inertial measurement units (IMUs)), altitude sensors, attitude sensors (e.g., compasses) pressure sensors (e.g., barometers), field sensors (e.g., magnetometers, electromagnetic sensors), and/or other sensor information (e.g., Wi-Fi data). The location of the user device can be used to locate an origin of a travel route. As an addition or alternative, a location of a place of interest (e.g., origin of a trip, destination of a trip, stops during a trip) may be provided by a user via the user device 103 such as by manually entering a location via a user interface. In some cases, the destination geographic location may be determined based at least in part on a user input. Systems and methods herein may be capable of processing a varieties of user input and determine a destination geographic location accordingly. For example, a user may enter the destination declaratively, such as “I want to go to the Moscone Center”, or through a query, e.g., “How do I get to the Moscone Center?” In some cases, the geographic location may be determined based at least in art on the user's calendar data (e.g., “meeting with X at location Y”).

The user device may include a communication unit, which may permit the communications with one or more other components in the network. In some instances, the communication unit may include a single communication module, or multiple communication modules. In some instances, the user device may be capable of interacting with one or more components in the network environment using a single communication link or multiple different types of communication links. The user devices 103 may interact with the personal transportation management system 101 by requesting and obtaining the aforementioned data via the network 110.

The user device may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations.

In some embodiments, users may utilize the user devices 103 to interact with the personal transportation management system 101 by way of one or more software applications (i.e., client software) running on and/or accessed by the user devices, wherein the user devices 103 and the personal transportation management system 101 may form a client-server relationship. For example, the user devices 103 may run dedicated mobile applications provided by the personal transportation management system 101.

In some embodiments, the client software (i.e., software applications installed on the user devices 103) may be available as downloadable mobile applications for various types of mobile devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms. In some cases, third-party user interfaces or APIs may be integrated to the mobile application and integrated in the front-end user interface (e.g., within a graphical user interface). The third-party user interfaces may be hosted by a third-party server. In some cases, APIs or third-party resources (e.g., map service provider, mobility service provider, digital service provider, Starbucks, McDonalds, Ticketmaster, etc.) may be used to provide and conduct a transaction with the user. In some cases, one or more third-party services may be called by the personal transportation management system 101 and integrated to the user application such that a user may access such services in a familiar front-end user experience. In some cases, one or more of the aforementioned services may be a built-in component of the personal transportation management system 101 and may be provided to the user without outsourcing a third-party entity. In some cases, data retrieved from the third-party service providers may be organized and stored by the personal transportation management system 101 to form a vendor/service catalog which may be used to determine a transactional offer to the user during transportation. In some cases, the personal transportation management system 101 may provide a graphical user interface (GUI). The GUI may permit the user to access, accept, reject, select one or more transactional offers/options by interacting with graphical elements, and viewing information such as a travel route and travel schedule during the transportation.

The user device may include a display. The display may be a screen. The display may be a touchscreen. As an alternative, the display may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). For example, the GUI may show graphical elements that permit a user to accept or reject a transactional offer, and view information related to a travel route and transaction options. Alternatively, or in addition to, the user device may be any personal digital assistants or devices such as smart watch or smart speaker that may not include a display.

The network 110 may be a communication pathway between the personal transportation management system 101, the user devices 103, and other components of the network. The network may comprise any combination of local area and/or wide area networks using both wireless and/or wired communication systems. For example, the network 110 may include the Internet, as well as mobile telephone networks. In one embodiment, the network 110 uses standard communications technologies and/or protocols. Hence, the network 110 may include links using technologies such as Ethernet, 802.11, worldwide interoperability for microwave access (WiMAX), 2G/3G/4G or Long-Term Evolution (LTE) mobile communications protocols, Infra-Red (IR) communication technologies, and/or Wi-Fi, and may be wireless, wired, asynchronous transfer mode (ATM), InfiniBand, PCI Express Advanced Switching, or a combination thereof. Other networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above. The network may be wireless, wired, or a combination thereof.

In some embodiments, a user may register with the system or subscribe to the personalized transportation service provided by the system. Data related to the user may be stored in a user database. FIG. 2 shows examples of user databases, 200, 210 in accordance with embodiments of the present disclosure. In some embodiments, a user database 200 may be configured to store personal data, plan data, historical data and others. The user data may be stored for each individual user.

In some cases, personal data 201-1, 201-N may include data related to an individual (e.g., user 1 or user N) such as identity, age, gender, contact information, demographic data and others. Such data may be inputted by the user during a registration process or after registration. Alternatively, or in addition to, such data may be extracted from other data sources or third-party applications. In some cases, personal data may also include user preferences.

User preferences may include both travel preferences and transactional/service preferences. The travel preference may be derived from one or more of various parameters acquired by the system, and used to generate a personalized travel route. For example, a travel preference such as a “fastest route” preference indicates a preference for the fastest (temporally) route between two points. A “shortest route” preference can indicate a preference for the shortest (distance) route between two points. A “most fuel-efficient route” preference can indicate a preference for fuel savings. A travel preference may indicate a preference for “effort” that may be especially relevant to cyclists, walkers, runners, hikers, and swimmers that may want, for example, large changes in grade (e.g., hills) or small changes in grade (e.g., flat). A travel preference may indicate a preference for a route with various scenic points, more vegetation than urban vistas, and the like, a preference for museums, theaters, playhouses, and the like, a preference for routes that include shopping opportunities, a preference for food, a preference by a user to avoid being stuck in traffic, even if the traffic-heavy route is the fastest path to their destination and various other preferences. A travel preference may include user-preferred transportation mode (e.g., autonomous vehicle, public transportation (such as train, light rail, or city bus), shuttle, ridesharing, ride-hailing, shared trip or private trip, walking, bicycle, e-scooter, taxi, etc.), or user experience inside a vehicle (e.g., access to music, game) and the like. The travel preferences may be used to determine the travel route, segments of a route, and/or stops (e.g., scenic views, restaurants, coffee shops, etc.) during the travel route. Such user preferences may be inputted by the user and/or extracted from other data sources or historical data.

In some cases, plan data may include calendar data 202-1, 202-N and to-do list data 203-1, 203-N. Calendar data or to-do list data may be collected from a calendar application or to-do list application running on the user device. In some cases, such plan data may also include data extracted from electronic mails (emails), text messages, or other planning, communication, or scheduling applications or channels.

The historical data may include transportation, purchase, and/or transaction history of the user. In some cases, an entry of a transportation history 204-1, 204-N may include data related to a trip or transportation. For example, an entry of a transportation history may comprise one or more of trip date, origin location, destination location, starting time, end time, transportation mode (e.g., autonomous vehicle, public transportation (such as train, rail, or city bus), shuttle, ride-sharing, ride-hailing service, shared trip or private trip, walking, bicycle, e-scooter, taxi, etc.) offered to the user, transportation mode selected by the user, price, wait time, vehicle type, interior configuration of a vehicle, configuration for each segment of the trip, calendar entry addressed, to-do list entry addressed, health inference based on transportation mode, ratings of the service, reputation score, customer complaints, and other historical data. Such historical data may be automatically recorded or tracked by the system. For instance, a transaction record may be stored in the user database when a transaction is completed.

The user database may comprise any other data related to the user. For instance, information related to loyalty programs (e.g., loyalty points), subscription data, ratings of the user may be stored in the user database.

In some instances, data derived from the aforementioned data may be stored in a user database 210. The database 210 for storing derived data can be integral to the user database 200 as described above. In some cases, the user database 210 may be a graph database. For example, the derived data may be stored as a graph data structure. Alternatively, or addition to, the database 210 may utilize any other suitable database techniques. In some cases, the derived data may include a visitation graph 211-1, 211-N, a social graph 212-1, 212-N, a purchase graph 213-1, 213-N, a transportation graph, 214-1, 214-N, and various other data.

A social graph 212-1 may help depict relationships between various users. In some cases, a social graph may also depict vehicles to facilitate in-car sharing, among other things. In some cases, a social graph may indicate the relationship between the user and other individuals and entities (e.g., family, business, friend, etc.), a road network, and potential meeting-spots within a community. In some cases, the social graph may be used for facilitating car sharing, offering recommended vehicles and locations, suggesting car sharing partners based on shared interests and mobility activities. In some cases, the social graph may be used to predict or recommend a location and/or schedule for the trip. For example, if the user is scheduled to meet someone in a business relationship with the user, the arrival time may be scheduled based on a business meeting preference. In some instances, a social graph may represent users as nodes and represent relationships between users as links. In some cases, the social graph may include properties related to the links or nodes. Links may arise from physical proximity, social networks (e.g., Facebook, Twitter, LinkedIn, etc.), historical communications (e.g., email, SMS, video chat, etc.), common membership in clubs, common membership in organizations, common membership and societies, family relationships, common employer, common workplace, and the like. Links can be established primarily for forming a vehicle sharing community. Each of the link properties may be a factor and may be weighted dynamically and/or individually for the social graph.

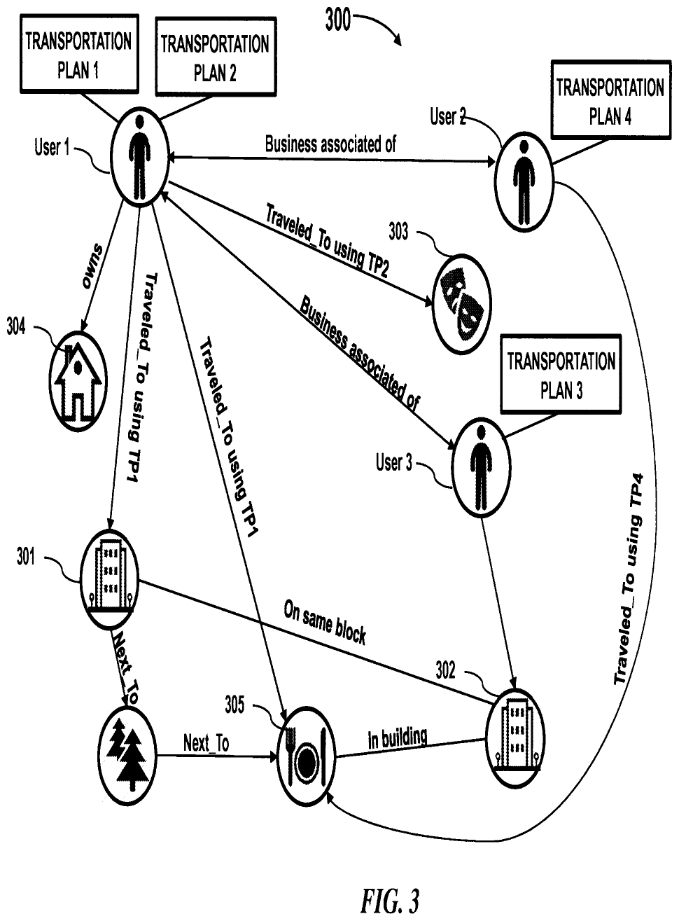

A transportation graph 214-1, 214-N may depict one or more relationships connecting people, places, and transportation plans. FIG. 3 shows an example of a transportation graph. In some cases, the transportation graph may comprise nodes representing people (e.g., user 1, user 2, user 3) and stationary locations (e.g., building 302, restaurants 305, museums, parks, theater 303, home 304, workplace 301, bus stop, etc.). In some cases, properties such as one or more transportation plans may be stored with a node corresponding to a user. A transportation plan may include a transportation mode (e.g., autonomous vehicle, public transportation (such as train, light rail, or city bus), shuttle, ridesharing, ride-hailing, shared trip or private trip, walking, bicycle, e-scooter, taxi, etc.). Where nodes in the graph correspond to locations that can be origins, destinations, or other locations, additional data might be stored associated with nodes. For example, an address or geolocation of a location might be stored as a property. The links connecting places may represent geolocation or temporal relationships (e.g., next to, on same block, in building, etc.). The links connecting a user and a place may represent a transportation relationship including a property indicating transportation mode (e.g., Traveled_To using transportation plan 1) or other relationships (e.g., owns). In some cases, the links connecting users may represent social relationships (e.g., business associated of). A transportation plan may be carried out in a time period that may be within a day, span across multiple days and the like. A transportation plan may comprise a start time and an end time. In some cases, multiple transportation plans associated with a user may be arranged according to the start time.

Referring back to FIG. 2, the visitation graph 211-1, 211-N may depict relationships between the user and various places/locations that were visited by the user at least once. In some cases, the visitation graph and the transportation graph may share same data or information. In some cases, the visitation graph may comprise additional or different information such as the frequency of visiting a place.

In some cases, the in-vehicle service or transaction options may be offered to users based on customer segmentation. The customer segmentation may allow the system to target a certain segment of the subscribers to make offers that may be relevant (e.g., found to be most relevant) to those subscribers. The subscribers or users may be segmented using any suitable segmentation technique. For example, the segmentation technique may be based on fixed rule sets. Subscribers may be grouped based on geography (or geolocation), social graph(s), purchase graph(s), transportation graph(s), demographic information, user preference(s), installed mobile application(s), or other user attribute(s) or characteristic(s) extracted from the user profile data, as described above. Subscribers in the same group may share one or more user attributes or subscriber characteristics (e.g., age, gender, geolocation, social graph, frequent flyer, frequent food shopper, etc.). An individual may belong to one or more segments. In some cases, the segments may be continuously augmented and updated automatically as new data is collected. Various transactional offers may be provided. For example, the offers may lead to commerce such (e.g., “30% off your next coffee at Starbucks”) or may resulting in a direct commerce transaction (e.g., “I want to charge my vehicle at the location presented/suggested by the application.”)

In some cases, the segmentation technique may be based on a pattern extracted from historical data (e.g., user profile data). The pattern may be extracted using a machine learning algorithm. In some cases, a set of patterns may be initially generated and an algorithm may be employed to identify an optimal allocation of patterns to segments that is both feasible and maximize a desired outcome. The desired outcome may be offering a select number of in-vehicle service or transaction options to be sent to appropriately chosen customers (e.g., a target group of customers) at an appropriate time and/or location such that the chosen customers are likeliest to accept the in-vehicle service. The initial set of patterns may be generated using any suitable method such as a decision tree or other pattern identification algorithm. In some cases, the algorithm for identifying an optimal allocation of patterns to segments may be a trained machine learning algorithm (e.g., support vector machine or neural network).

Data related to the customer segmentation may be stored in the subscriber database. The user data may be stored and organized in the subscribed database according to customer segments. The customer segmentation may be updated periodically or upon detection of new data being added to the subscriber database. Such update(s) may be performed automatically or manually.

When a new user registers with the system or subscribes to the personalized transportation service provided by the system, the user may be assigned to one or more segments. The segment to which the user is assigned may be updated with time. In-vehicle service or transaction options associated with a given customer segment may be updated as new data (e.g., purchase data, transaction data, transportation data, etc.) are collected and analyzed by the system.

A transportation plan may be personalized for an individual based on the aforementioned data. In some embodiments, a travel route may be generated automatically upon receiving an origin location and a destination location. The travel route may comprise one or more segments. In some cases, the personalized transportation plan may also include a transportation mode determined for each segment and a schedule (e.g., departure/begin time, arrival/end time for the trip or a segment). The personalized transportation plan may also include offering one or more transactional options to the user during the transportation. A user may conduct one or more transactions facilitated by the system. In some cases, the destination or a stop during the trip may be predicted by the system based on calendar data and/or to-do list data. In some cases, a stop (e.g., coffee shop) during the trip or a next destination may be predicted by the system based on user data (e.g., historical data) or a combination of plan data (e.g., calendar data and/or to-do list data) and historical data.

The present disclosure also provides methods and systems for providing a passenger with a personalized trip experience that may be based at least in part on a context of a destination or a stop of the passenger along a trip. The destination or stop during the trip may be analyzed by the system to extract contextual information. Such contextual information may be used to determine one or more transactional options, vehicle options, and/or in-vehicle settings for personalizing the trip. The contextual information may be relevant to or indicate a likely or an actual (e.g., predetermined) action. For example, the contextual information, such as a coffee shop, a flight to a particular destination (e.g., a flight from San Francisco to New York), restaurant, stadium, theater, or dental clinic may be relevant to activities such as drinking coffee, business trip, dining, attending a football game, attending a show, getting dental treatment or any other type of medical examination and/or test and the like. Such contextual information may be associated with the identity of the destination or stop, or an event associated with the destination or stop (e.g., a baseball game, a baseball stadium, etc.). In some cases, the contextual information may relate to activities that are typically associated with a particular location. For example, before a domestic flight that is expected to last over 3.5 hours, the passenger flying in a coach class may be offered to order a meal to pick up prior to boarding. In another example, a passenger who is about to attend a theatrical event may be offered a table reservation at the theater's bar for a drink during the performance's intermission. In some cases, the contextual information may be obtained by extracting a data pattern from multiple users' trip data. For instance, by analyzing trips that are arriving at approximately the same time to the same location, such as a residence, it may infer that an event or group activity (e.g., party) is taking place at the location. Based on this contextual information, one or more transactional options or mobility services related to the group activity, such as purchasing a bottle of wine to bring to the party, or ordering food from a vender to be delivered to the party, may be provided to the passenger(s) during the trip.

Based on the contextual information and the likely activities, the trip can be personalized. For instance, one or more in-vehicle settings during a trip may be automatically adjusted based on the destination context. For example, if the destination context (e.g., dental clinic) indicates a medical treatment to be taken at the destination, the temperature, humidity, air freshener, or music service may be adjusted to provide a comfort in-vehicle ambient environment and help the passenger relax. In another example, if the destination context (e.g., Starbucks) indicates the user will have coffee at the destination, the user may not be offered coffee transactions during the trip. In some cases, the in-vehicle services or transactions may be offered to a passenger in a personalized manner based on the destination context. For example, in-vehicle services such as a wake-up service or massage service may be personalized based on the time of arrival at the destination location and the destination context. In some cases, the associated equipment such as exercise equipment, massage chairs or nap pods, may be automatically set up and controlled based on the personalized service. The contextual information can be extracted using any suitable methods and models, such as, for example, natural language processing (NLP) algorithms, Named Entity Recognition (NER), linguistic analysis, and/or machine learning models (e.g., support vector machine or neural network). In some cases, the contextual information may be extracted from a passenger condition/activity in the vehicle. The contextual information may relate to a passenger's mood, stress level, health condition, passenger behavior (e.g., sleep) or others. For example, one or more sensors, such as electrocardiogram (ECG) sensors, sweat-rate sensors, and/or respiration-rate body sensors, may be used to assess a passenger's stress level, and stress-reduction options, such as music, lighting, and/or humidity level, may be automatically adjusted to reduce the passenger's stress level. Other sensors, such as a vision sensor (e.g., camera) and/or artificial intelligence (AI) techniques, may be used to analyze the passenger's behavior (e.g., sleep) so as to automatically control in-vehicle settings (e.g., music, lighting, and/or humidity level). Such AI may include one or more machine learning algorithms, such as a neural network or support vector machine.

For example, a user may be traveling in a vehicle as a passenger from San Francisco to Santa Clara to attend a football game. The context may be determined to be football and/or the football team. The user's travel experience may be customized to provide the user with music that is specific to football or the football team.

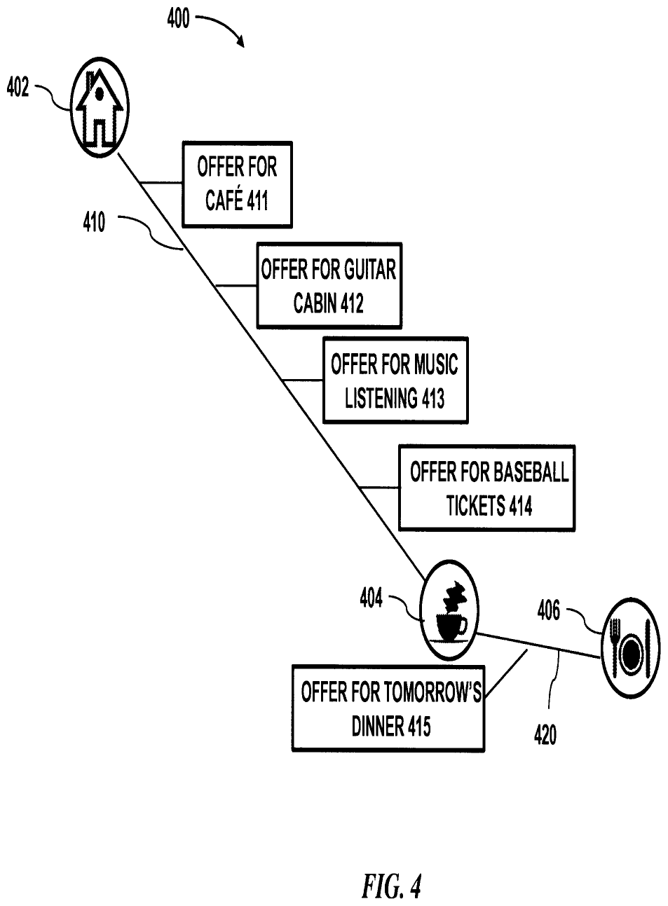

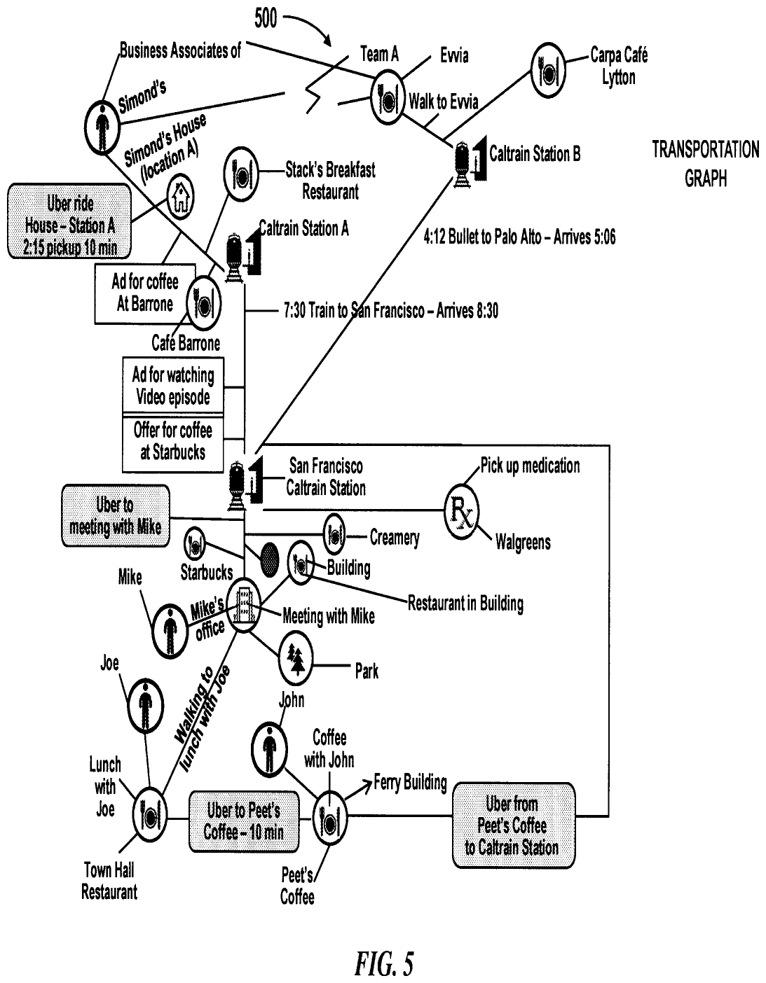

FIG. 4 and FIG. 5 show examples of personalized transportation plans 400, 500. As shown in FIG. 4, the travel route comprises two segments 410, 420. The origin location 402 of the travel route may be inputted by the user via a GUI or automatically detected by a Global Positioning System (GPS) of the user device. The destination location 406 of the travel route may be automatically determined by the system based on calendar data or to-do list data. Alternatively, or in addition to, the destination location may be entered by the user.

During transportation along the first segment 410 of the trip, the user may be offered one or more transactional options (e.g., offer for cafe 411, offer for quiet cabin 412, offer for music listening 413, and offer for baseball ticket 414). During the second segment 420, the user may be offered transactional options such as offer for today's dinner 415. Such one or more transactional offers may be presented to the user in a GUI of the user device or on a display in the vehicle. In some cases, one or more stops during the travel route may be generated based on a user response to a transactional offer. In the illustrated example, a user may accept a coffee offer 411 and conduct a transaction. Upon receiving the acceptance, the travel route may be updated with a stop at a coffee shop 404. As described elsewhere herein, a transportation mode (e.g., autonomous vehicle, public transportation (such as train, light rail, or city bus), shuttle, ridesharing, ride-hailing, shared trip or private trip, walking, bicycle, e-scooter, taxi, etc.) may be determined for each segment. The transportation mode for the first segment 410 may be the same as the transportation mode for the second segment 420. Alternatively, the transportation mode for the first segment may be different from the transportation mode for the second segment.

In some cases, a plurality of transactional options are presented to a user concurrently. Alternatively, or in addition to, a plurality of transactional options may be presented to a user sequentially. In some cases, the timing for providing one or more passenger commerce options may be based on a current geolocation of the user and/or travel time. In some cases, a user may not be presented a next transaction option until the previous one is conducted or turned down. The timings and selections of one or more transaction options offered to a user may be determined by a transport plan engine. In some cases, the transport plan engine may include a recommendation engine configured to determine transactional offers. In some cases, the transport plan engine may include a model built using artificial intelligence, such as using a machine learning algorithm (e.g., neural network) that may determine the timing and selection of transactional options. The transport plan engine and/or the recommendation engine can be components of the provided system. The terms “passenger commerce options” and “transactional options” are used interchangeably herein.

FIG. 5 shows another personalized transportation plan 500. In some cases, at least a portion of the travel is determined during the transportation. The transportation plan or travel plan may be updated in real-time based on one or more transactions the user has conducted during the trip or based on changes to the user's calendar. In some cases, the travel route and transportation plan may be displayed on a GUI to the user. The user may be permitted to interact with one or more of the graphical elements to, for example, accept or turn down a transactional offer/option, conduct a transaction, modify a stop or destination, modify a transportation mode, and various others.

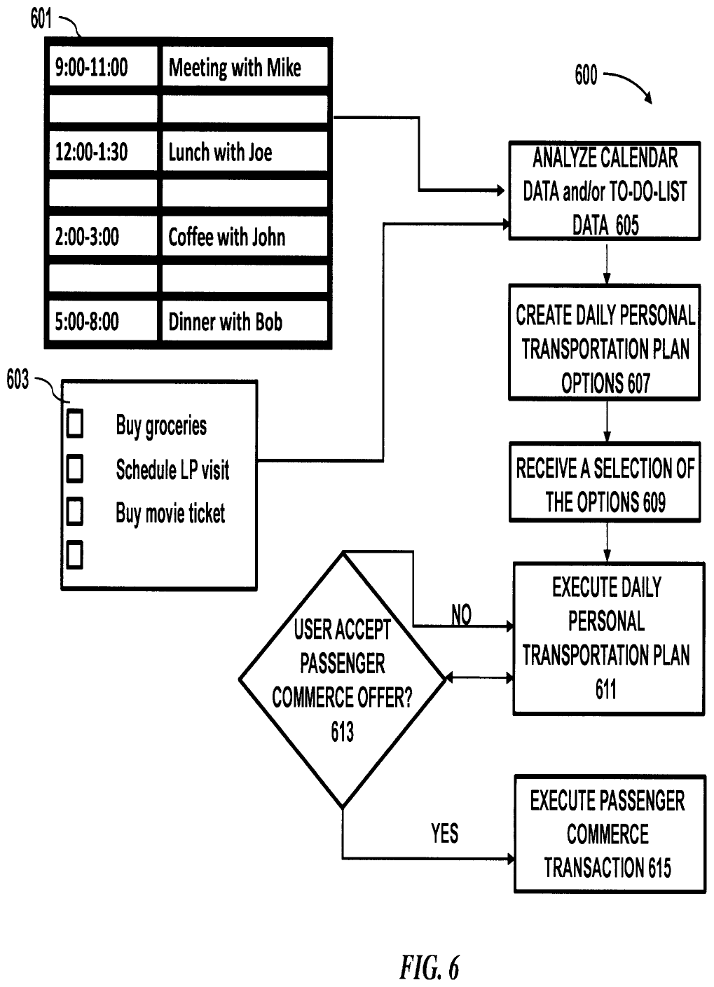

FIG. 6 shows an example process 600 of generating one or more transactional options for a user during a daily transportation. In the illustrated example, calendar data 601 and to-do list data 603 may be obtained and analyzed (operation 605). A daily personal transportation plan may be generated and may provide one or more options for a user to select (operation 607). The one or more options may include, for example, stops (e.g., restaurant for lunch with Joe, coffee shop for coffee with John, grocery store) during the trip, transactional options to be presented during the trip (e.g., purchase movie ticket), and transportation mode options for a segment (e.g., autonomous vehicle ride-hailing service from location to meet Mike to location to lunch with Joe, human-driven ride-hailing service from cafe shop to grocery store, etc.). A user may make a selection of the one or more options via a GUI or other approaches (e.g., voice command or gesture) (operation 609). Alternatively, or in addition to, a selection may be made by the system without user intervention. The personal transportation plan may be executed and one or more transactional options or passenger commerce offers may be displayed to the user (operation 611). For example, one or more transactional options may be delivered to the user in a visual manner (e.g., displayed on a user device, in-vehicle monitor, a built-in display on an e-Scooter or other vehicles, etc.), in acoustic manner (e.g., interactive voice response (IVR) systems, smart speaker, etc.) or a combination of both. A user may be prompted to accept or turn down a transaction option (operation 613). In some cases, if a user turns down a transactional offer, a new transactional option may be presented. In some cases, if a user accepts a transaction option, the user may be prompted to conduct and complete the passenger commerce transaction (operation 615).

Although FIG. 6 shows a method in accordance with some embodiments, a person of ordinary skill in the art will recognize that there are many adaptations for various embodiments. For example, the operations can be performed in any order. Some of the operations may be precluded, some of the operations may be performed concurrently in one step, some of the operations repeated, and some of the operations may comprise sub-steps of other operations. For instance, in some cases the transactional options are presented to a user sequentially and a user may not be presented a next transactional option until the previous one is conducted or rejected. In some cases, the timing for providing one or more passenger commerce options may be based on a current geolocation of the user and/or travel time. The method may also be modified in accordance with other aspects of the disclosure as provided herein.

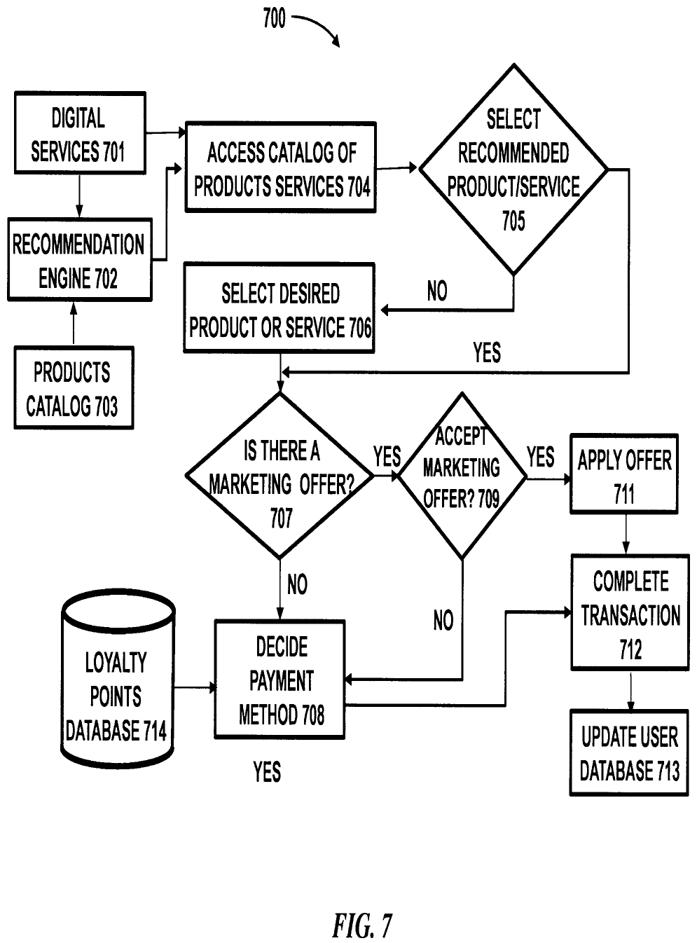

FIG. 7 shows an example process 700 of providing personalized passenger commerce during transportation. In some embodiments, the provided system may comprise a recommendation engine 702 configured to select one or more transactional options to offer to a user. Third-party services such as digital services 701 and products catalogs 703 are accessible by the recommendation engine. In some cases, upon receiving an instruction requesting a transactional offer, the recommendation engine may access catalog of products and services 704 and determine a recommended product or service 704. In some cases, the recommended product or service may be selected or determined based on user data. In some cases, if no recommended product or service can be determined, one or more candidate options may be presented to the user for selection. In such cases, a user may select a desired product or service 706. Alternatively, or in addition to, a user may be permitted to enter a desired product or service manually. Upon determining a recommended or desired product/service, the system may look up for an available marketing offer 707. If an offer is available, a user may be prompted to accept or reject the offer 709. The offer may be applied to the transaction 711 if it is accepted by the user. In the case when the marketing offer is not accepted, a payment method may be decided 708 and loyalty information may be retrieved from loyalty points database 714 to calculate a final payment. The transaction may then be completed 712 and the user database may be updated 713 with the data related to the transaction. The transaction may be completed regardless the payment methods (e.g., credit card, virtual cash such as Uber Cash, etc.). For example, a user may be prompted to choose a user preferred payment method on the user device or via an in-vehicle device.

In some embodiments, the recommendation engine may be a component of a transport plan engine or be coupled to a transport plan engine. The transport plan engine may be configured to generate a travel route with personalized passenger commerce offers provided to the user during transportation. In some cases, the transport plan engine may determine when and/or where to provide the passenger commerce offers. In some cases, the transport plan engine may generate an instruction to the recommendation engine to request a transactional option. In some cases, the timing and/or location to present a passenger commerce offer, or the selection of a passenger commerce offer may be automatically determined by a machine learning-based model of the transport plan engine.

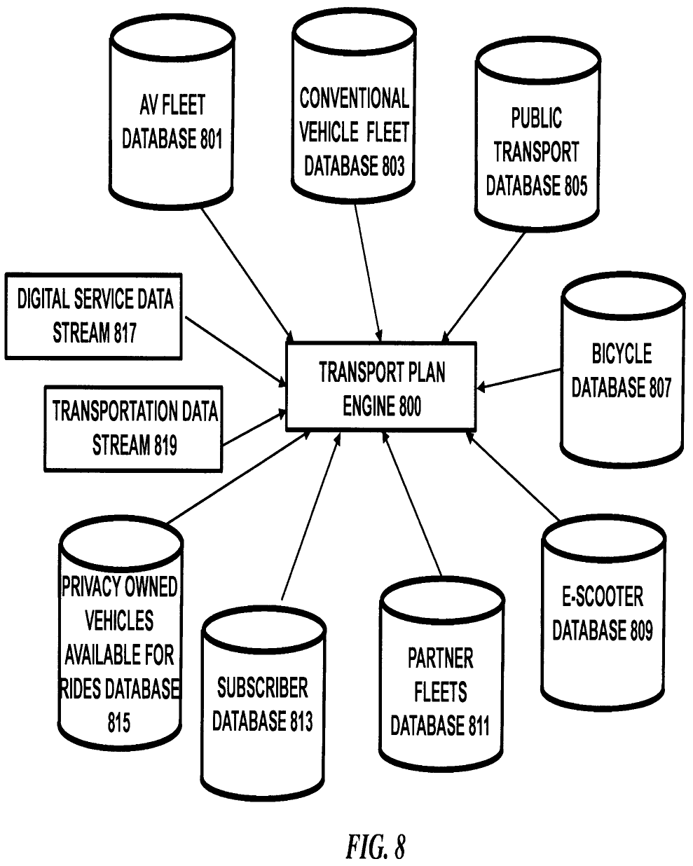

FIG. 8 schematically shows a transport plan engine 800 coupled to a plurality of databases and sources of data for generating a personalized transportation experience. As shown in FIG. 8, the transport plan engine 800 may be capable of accessing a plurality of databases or data sources such as an autonomous vehicle fleet database 801, a conventional vehicle fleet database 803, a public transport database 805, a bicycle database 807, a e-scooter database 809, a partner fleets database 811, a user (subscriber) database 813, a privacy owned vehicles available for rides database 815, as well as data streams such as digital service data stream 817 and transportation data stream 819. The transport plan engine 800 may retrieve data from one or more of the aforementioned databases and data sources to generate a travel route including stops or destinations, determine one or more transactional options to offer a user, determine timings/locations to represent a given transaction offer, and various others.

In some embodiments, a personalized transportation plan may be generated prior to starting a trip. In some embodiments, at least a portion of the personalized transportation plan may be generated during the transportation. For instance, a transportation plan may be generated in a step-by-step fashion. A step of a transportation plan may include a segment (e.g., transportation mode, schedule), a transactional option to offer to a user, a new destination or stop and various others. In some embodiments, at least a portion of the personalized transportation plan may be adjusted during the transportation.

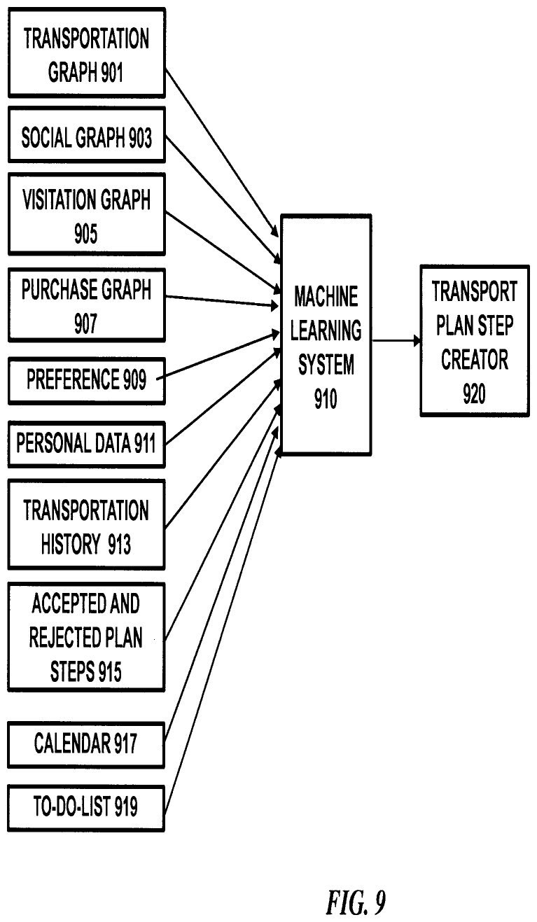

FIG. 9 shows a block diagram of a transport plan step creator 920. In some cases, the transport plan step creator may be a component of a transport plan engine as described elsewhere herein. In some cases, the transport plan step creator can be the same as the transport plan engine. In some embodiments, the transport plan step creator 920 may include a machine learning system 910. Input data supplied to the machine learning system 910 may comprise historical data such as transportation graph 901, social graph 903, visitation graph 905, user preference 909, personal data 911, transportation history 913, and previous accepted and rejected plan steps 915. The input data may also comprise calendar data 917 and 919. The output of the machine learning system 910 may be a step of a transportation plan. The step may include a segment (e.g., transportation mode, schedule), a transactional option to offer to a user, or a new destination or stop. Automated Marketplace System

In another aspect of the present disclosure, an automated marketplace system is provided. The automated marketplace system can facilitate matching of transportation services to the personalized transportation plan generated by other systems described herein.

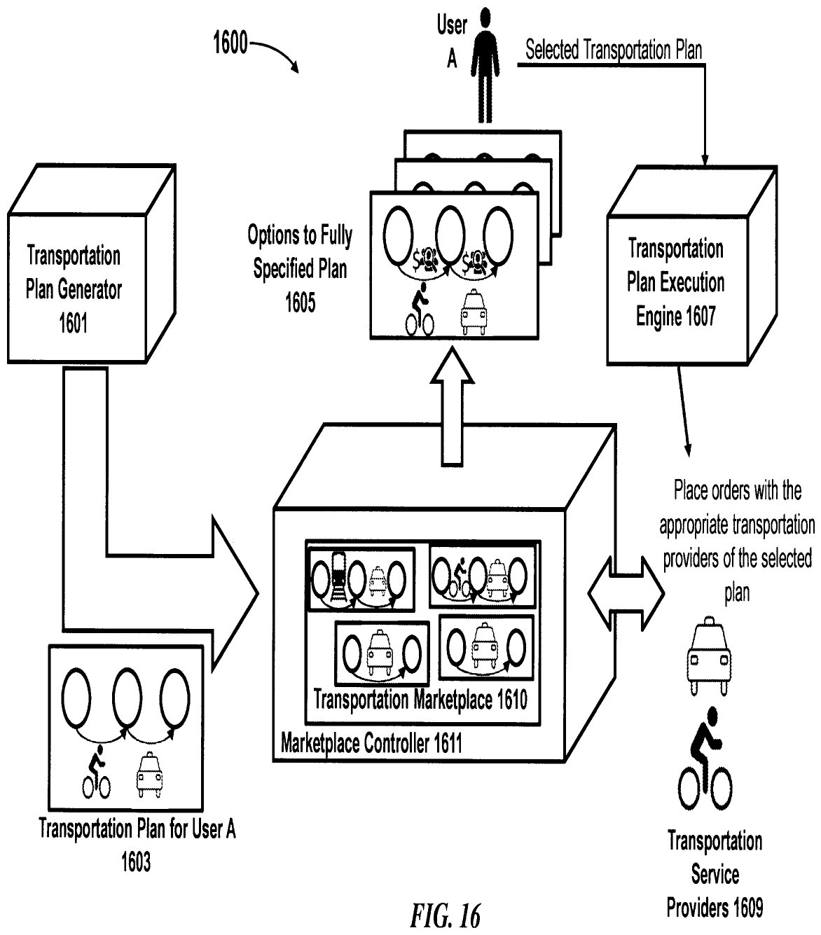

FIG. 16 illustrates an example of a transportation marketplace platform 1600 in accordance with some embodiments.

The transportation plan generator 1601 may create a personalized transportation plan 1603 for each user, e.g., User A. The transportation plan generator 1601 can be the same as or similar to the transportation plan generator as described above. For example, the transportation plan generator may be capable of generating personalized transportation plan 1603, predicting the next trip and the like based on data retrieved from the user database (e.g., calendar and to-do list) and vehicle database.

The transportation plan generator 1601 may send the transportation plan (e.g., transportation plan for User A 1603) to the transportation marketplace 1601. As described above, a personalized transportation plan may include a travel route, schedule of one or more segments/components of the travel route (e.g., departure time, arrival time, etc.). The transportation plan may also include the transportation modalities that will be used during the travel. For example, a transportation plan may comprise public transportation modalities, such as train, subway, shuttle, and on-demand corporate modalities (e.g., ride-hailing). In such cases, the prices for that component/segment of the transportation may be fixed or pre-determined. In some cases, a component of a transportation plan may be associated with a segment of a transportation route.

In the illustrated example, a transportation plan for a user, e.g., User A, may be created based on User A's calendar data, to-do list data, the predicted trip type, and/or transportation objectives/preferences. The transportation objectives/preferences may include, for example, shortest travel/transport time to destination, lowest total price of trip with discount offers, lowest total price without discount offers, shortest wait time for each pickup, non-use of any modalities involving ridesharing, include ridesharing modalities if it does not delay time of arrival to final destination, and various other preferences. A user may be permitted to set up the transportation objectives/preferences (e.g., User_Objectives) on a trip-by-trip basis, for one or more selected trips, or for all of the trips.

In the illustrated example, the transportation plan 1603 sent to the transportation marketplace 1610 may include, for example, Transportation Plan ID, User ID, Plan Components, Time Limit, and User Objectives. The Time Limit may specify the time by which the user with User ID is to receive a priced transportation plan from the marketplace controller 1611. The user objectives may include at least a subset of the transportation objectives/preferences selected for the trip.

The Plan Components may include an ordered sequence of records that can include a Component ID, a Component Origin provided in terms of a longitude and a latitude (e.g., a Point of Interest (POI) in the mapping terminology), a Component Destination provided in terms of a longitude and a latitude (e.g., POI), Transportation Modality (i.e., transportation mode), Suggested Start Time at Origin, Suggested Arrival Time at Destination, Actual Start Time at Origin, Actual Arrival Time at Destination, Transportation Provider ID, Component Price Bids, Actual component Price, and Selected Flag. In some cases, only the transportation plan components/segments that are subject to price bidding from the transportation providers may be transmitted to the marketplace controller.

In some cases, the Component Origin of Plan Componentₙ may be the Component Destination of Plan_Componentₙ₋₁. Some of the objects such as Transport_Provider_Name, Actual Start Time at Origin, and Actual Arrival Time at Destination for each Plan Component, and Component Price can be initially left empty, to be filled by the transportation marketplace or transportation providers as part of the bidding process. The Actual Start Time at Origin of Plan Componentₙ may be no earlier than the Actual Arrival Time at Destination of Plan Componentₙ₋₁.

In some cases, the transportation plan generator 1601 may be in communication with the marketplace controller 1611 using a Transportation Plan Message. The Transportation Plan Message may include a unique identifier for the message being created (e.g., Transportation Plan Message ID) and a unique transportation plan ID with a pointer to the actual Transportation Plan that has the Transportation Plan ID.

The transportation marketplace 1610 may post at least a portion of the transportation plan 1603 as a bidding request to the transportation providers 1609. For example, the transportation marketplace may send bidding requests for the components of the transportation plan that require transportation services from the transportation providers, while the components that do not require bidding price (e.g., public transportation) may have the prices filled by the transportation marketplace.

Each transportation provider may have a unique record in a Transportation Provider database. The transportation provider record may include, for example, a Transportation Provider ID, Operating Regions Set, and Vehicles_in_Fleet. The Operating Regions Set may include, for example, Operating Geographic Region which may be described in terms of the longitude and latitude pairs of a polygon defining the boundaries of the target area, such as San Francisco's financial district, or New York City, and a set of Supported Transportation Modalities by the Transportation Provider in the Operating Geographic Region, such as ride-hailing or micromobility. The Vehicles_in_Fleet may be a pointer to the Vehicle Database (1105 in FIG. 15) of vehicles that the transportation provider operates for the mobility services it offers. Each record in this database may correspond to a different vehicle in the transportation provider's fleet.

Depending on the modalities described in the plan, the transportation providers may bid for one or more components of the transportation plan that can be accomplished by the modality they offer.

The transportation provider may communicate with the Marketplace Controller 1611 using a message, e.g., Transportation Provider Message. A transportation provider message may include, for example, a Message ID, a Transportation Provider ID, a Message Type (e.g., New_Registration, Remove_Transportation_Provider, New_Bid, Add_to_Operating_Region, Add_Modality_to_Operating_Region, etc.), and a Payload. The payload may be determined by the Message Type. For example, a New_Registration type message may include the Operating_Regions_Set serviced by the Transportation_Provider, whereas New_Bid may include the price for providing transportation using a specified modality in a particular segment of a transportation plan created by the transportation plan generator.

The transportation provider may use the above messages to register with the transportation marketplace, expand or contract the operating geographic region (e.g., expand from serving only the San Francisco Financial District to serving the entire city of San Francisco, or remove serving the city of Austin), add or remove supported transportation modalities within an operation geographic region, and various others. As an example, a registration message may include:

Message_ID: Message_1

Transportation_Provider_ID: Transportation_Provider_A

Message_Type: New_Registration

Payload: ((New York, (ride-hailing, micromobility)), (San Francisco Financial District, (ride-hailing)), and/or other objects.

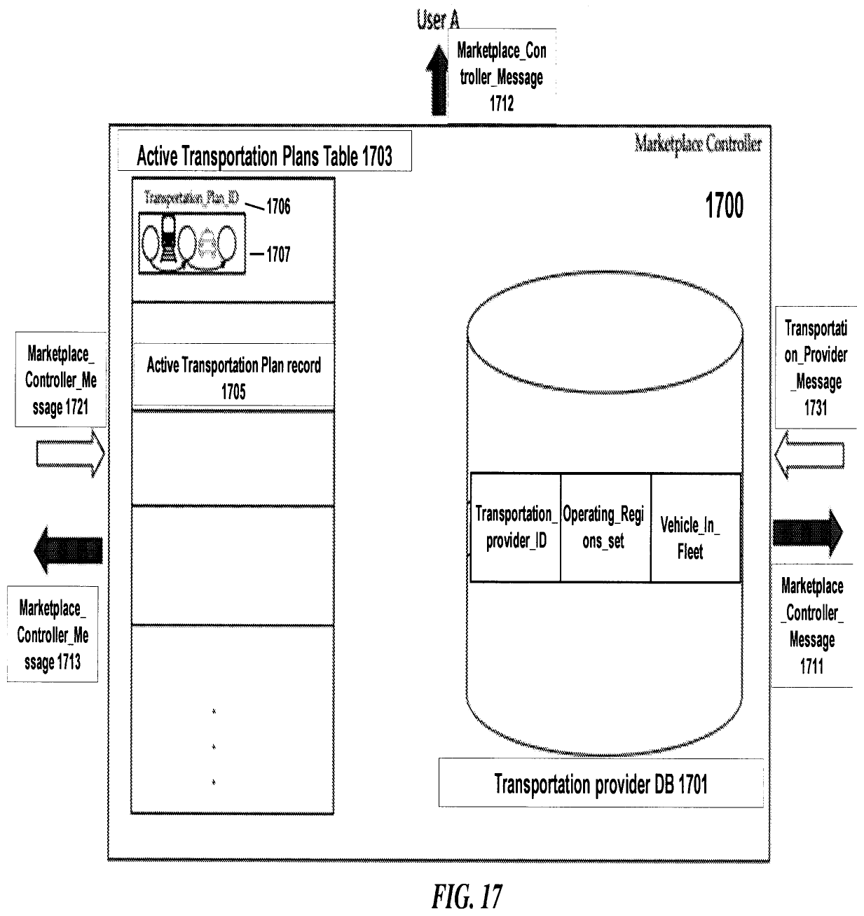

The marketplace controller 1611 can continuously monitor for the incoming Transportation Plan Message and the Transportation Provider Message. These messages may be received asynchronously. FIG. 17 schematically shows a marketplace controller 1700, in accordance with some embodiments. The marketplace controller 1700 can be the same as or similar to the marketplace controller as described elsewhere herein. The marketplace controller 1700 may include or be coupled to a transportation provider database 1701 and an active transportation plans table. The active transportation plans table may store a plurality of records. For example, a record 1705 may include Transportation_Plan_ID 1706 and a Transportation_Plan 1707. It should be noted that various other data structures can be utilized to store the records.

Referring back to FIG. 16, upon receiving a new message, the marketplace controller 1611 may process the bids (e.g., transportation provider message) and match them to the bid request (e.g., transportation plan message). The bids can be submitted within milliseconds or a few seconds after a bidding request has been posted. The marketplace controller may then send the winning bid (e.g., transportation service offer) to the user. The user may determine whether the time and/or price is acceptable. Once a bid for each component/segment is selected by the user, the Transportation Plan Execution Engine 1607 may notify the relevant Transportation Providers.

In some embodiments, the marketplace controller 1700 may query a transportation provider database 1701 to identify one or more service providers based at least in part on an origin location, a destination location and a transportation mode associated with at least one component from the plurality of components. The marketplace controller may then send a bidding request to the one or more identified transportation providers. The transportation provider database 1701 may be configured to store at least an operating geographic region and a transportation modality associated with each service provider. The one or more service providers can be identified by finding a match between the origin location, destination location in the transportation plan and the operating geographic region associated with a service provider, and a match of the transportation modality. The marketplace controller may receive one or more bidding prices from one or more transportation service providers (e.g., Transportation_provider_message 1731). The marketplace controller may transmit one or more transportation options to a user device for display, and each transportation option may include at least the price and the transportation plan. For example, the marketplace controller may send to User A the one or more transportation options using the Marketplace_Controller_message 1712.

Below is an exemplary process of the automated marketplace controller processing a bidding request. Upon receiving a new message, the marketplace controller may:

1. Check If the Received_Message_Type=Transportation_Plan_Message (e.g., Transportation_Plan_Message 1721 in FIG. 17) Then

1.1 Create a new record in the Active_Transportation_Plans_Table 1703 that contains the Transportation_Plan_ID 1706 and the Transportation_Plan 1707.

1.2 Query the Registered Transportation Providers database 1701. For example, the marketplace controller may check if the Component_Origin, and associated Component_Destination of at least one Plan Component in the Transportation_Plan is within the Transportation Provider Operating Geographic Region, and check if the Transportation Modality that will be used in the particular Plan Component is one of the Supported Transportation Modalities in the relevant Operating Geographic Region.

1.3 If the query returns empty, e.g., NIL (indicating the Transportation_Plan with the particular Transportation_Plan_ID cannot be satisfied), Then the marketplace controller sends to the transportation plan generator a Marketplace Controller Message (e.g., Marketplace_Controller_Message 1713 in FIG. 17) containing the pair Transportation_Plan_Message_ID, NIL.

1. 4 Else Sends to each identified Transportation Provider a Marketplace Controller Message 1711 that contains: the Transportation_Plan_ID, the entire Transportation_Plan, the Time_Limit for responding with a bid.

2. When the Time_Limit associated with Transportation_Plan_ID expires, the marketplace controller may:

2.1 Retrieve all bids submitted for the transportation plan with the particular Transportation_Plan_ID

2.2 If retrieved set is NIL, then the marketplace controller may send to the Transportation Plan Generator a Marketplace_Controller_Message (e.g., Marketplace_Controller_Message 1713 in FIG. 17) containing the pair Transportation_Plan_Message_ID, NIL (indicating to the Transportation Plan Generator that the Transportation_Plan with the particular Transportation_Plan_ID cannot be satisfied), or else associate all prices provided for each Plan_Component with the appropriate Plan_Component of the Transportation_Plan in the record.

2.3 The marketplace controller may send a Marketplace_Controller_Message 1712 containing the updated (priced) Transportation_Plan to the user whose User_ID is included in the Transportation_Plan with specific Transportation_Plan_ID.

3. Else if the Received_Message_Type=Transportation_Provider_Message Then

3.1 If the Message_Type=New_Registration Then the marketplace controller may create a new record in the Registered Transportation Providers database, copy the Transportation_Provider_ID in the new record and copy the Operating_Georgraphic_Region_Set from the message Payload to the new record.

3.2 Else If the Message_Type=Remove_Transportation_Provider Then the marketplace controller may use the Transportation_Provider_ID in the message to search the Registered Transportation Providers database for the record with the same Transportation_Provider_ID and remove the record from the Registered Transportation Providers database.

3.3. Else If the Message_Type=Add_to_Operating_Region Then the marketplace controller may use the Transportation_Provider_ID in the message to search the Registered Transportation Providers database for the record with the same Transportation_Provider_ID, and append to the identified record's Operating_Regions_Set the list included in the message's Payload. Each member of that list includes a region (described in terms of the mapping coordinates that form a polygon) and the transportation modalities the Transportation Provider will be operating in this region.

3.4 Else If the Message_Type=Add_Modality_to_Operating_Region Then the marketplace controller may use the Transportation_Provider_ID in the message to search the Registered Transportation Providers database for the record with the same Transportation_Provider_ID, search the record's list of the Operating_Regions_Set to identify the Operating_Region that matches the Operating_Region in the message's Payload, and append to the list of modalities associated with the identified Operating_Region the modality in the message's Payload.

3.5 Else If the Message_Type=New_Bid Then the marketplace controller may find in the Active_Transportation_Plans_Table 1703 the record with the Transportatoin_Plan_ID referred to by the received Transportation_Provider_Message 1731 and checks if Time_Message_Received<=Time_Limit Then Append the priced transportation plan to the record Else it Rejects the bid (e.g., by sending the Marketpace_controller_message 1711).

Upon receiving the priced transportation plan 1605, the marketplace controller may send the priced transportation plan 1605 to the user with the specific User ID. The user may select the desired providers and forward the updated Transportation Plan to the Transportation Plan Execution Engine 1607. The Transportation Plan Execution Engine 1607 may notify the appropriate Transportation Providers to execute the relevant Plan Component.

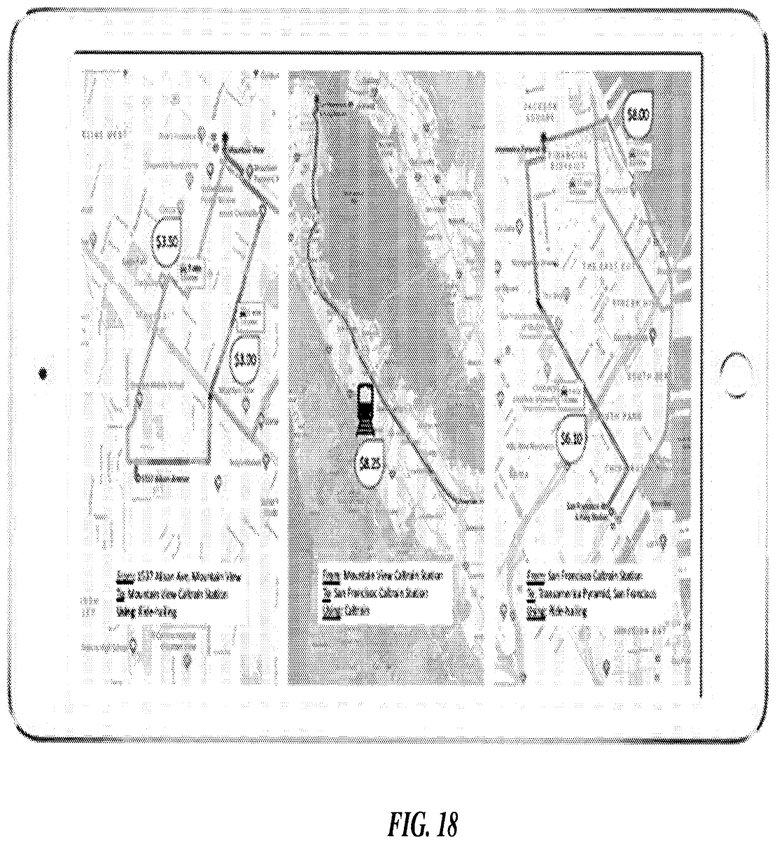

FIG. 18 illustrates an example of a graphical user interface for displaying multiple options of priced transportation plans. In the illustrated example, a user plans to go from 1537 Alison Ave in Mountain View to the Transamerica Tower in San Francisco for a meeting that starts at 10:00 am. The Transportation Plan Generator may automatically generate a transportation plan including: pickup from 1537 Alison Ave to the Mountain View Caltrain Station using ride-hailing, board the 8:12 am Caltrain to San Francisco arriving at 9:11 am, pickup from San Francisco Caltrain station to the Transamerica Tower using ride-hailing. Next, the transportation marketplace may provide prices for the ride-hailing component of the trip via a process as described above. The user may then be presented with the priced transportation plan. In some cases, a user may be presented with multiple options to select a desired option.

### Mobility Measurement

In some embodiments, the transportation or mobility data generated by the abovementioned system/methods may be further analyzed to measure the mobility as a service effort of a town, city, state, country or any levels. Such measurements can be used by automakers, vehicle insurance companies, city, county, state and country governments, retailers (e.g., supermarkets, home improvement retailers, department stores etc.), hospitality services companies (e.g., hotels, restaurants, coffee shop chains), and/or mobility services companies/organizations to understand how well mobility and other types of transportation-related services are received by consumers.

In some embodiments, a method for quantifying mobility services is provided. The method may include calculating personal mobility and goods delivery mobility. In some cases, the personal mobility may be calculated for a specific individual and for a measured time period (e.g., a day, a week, a month, etc.). The personal mobility may include a calculation of the ratio of distance traveled using a specific mobility over a total distance traveled in the measured time period. The personal mobility may include information about the percentage of an individual using different transportation modes/mobility services. Below is an example of formula for the personal mobility measurement:

$$\frac{POVMT}{TMT} , \frac{PTMT}{TMT} , \frac{MSMT}{TMT} , \frac{WMT}{TMT} , \frac{PMMT}{TMT}$$

Where POVMT represents the miles traveled using privately owned vehicles, PTMT represents the miles traveled using public transportation, MSMT represents the miles traveled in any type of mobility service (ride-hailing to shared micro mobility), WMT represents the miles walked, PMMT represents the miles traveled using personal micro mobility, and TMT represents the total miles traveled during the measured period, i.e., TMT=POVMT+PTMT+MSMT+WMT+PMMT. The personal mobility measurement can also include any other modalities including, but not limited to e.g., carpooling using privately owned cars, company buses and the like.

The delivery mobility may include information about the percentage of deliveries for different types of services/goods. The delivery mobility may be quantified using the below formula:

$$\frac{ECGDM}{DSM} , \frac{GDM}{DSM} , \frac{RDM}{DSM}$$

Wherein ECGDM represents e-commerce goods delivery miles (or anything that can be delivered by the shipping services such as UPS, FedEx, Amazon that support e-commerce purchases of physical goods), GDM represents grocery delivery miles, RDM represents restaurant delivery miles, and DSM represents the total delivery services miles, i.e., DSM=ECGDM+GDM+RDM. DSM also represents the miles “saved” by the individual by not traveling to the locations from where the goods were delivered.

POVMT may be further broken into sub-categories such as POVMT (shopping), POVMT (grocery shopping), POVMT (restaurant drives), POVMT (errands), and the like. POVMT represents the miles traveled using an individual's privately owned vehicle for shopping, grocery shopping, to going to restaurants. MSMT may be further broken into sub-categories such as MSMT (shopping), MSMT (food shopping), MSMT (restaurant drives), MSMT (errands), etc. MSMT represents the miles completed using a mobility service such as ride-hailing for shopping, grocery shopping, or going to restaurants.

The mobility measurement may be calculated using below formula:

$$\frac{G D M}{( P O V M {T}_{grocery shopping} + G D M )} , \\ \frac{R D M}{( {POVMT}_{restaurant drives} + RDM )} , …$$

The mobility measurement can be quantified at various levels including but not limited to, household level, neighborhood level, or any other demographic segment level (e.g., town, city, state, etc.).

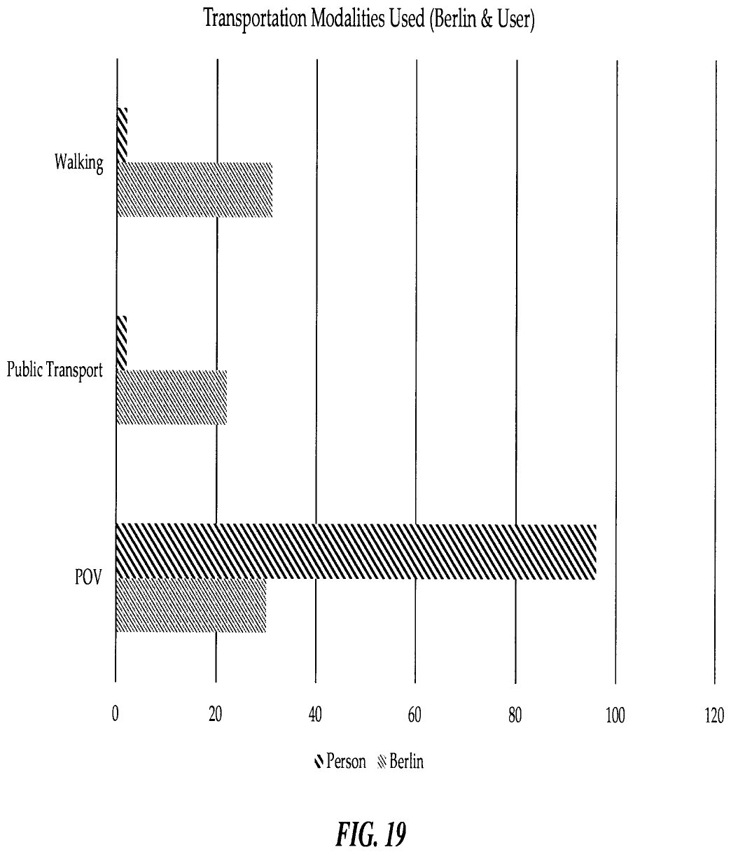

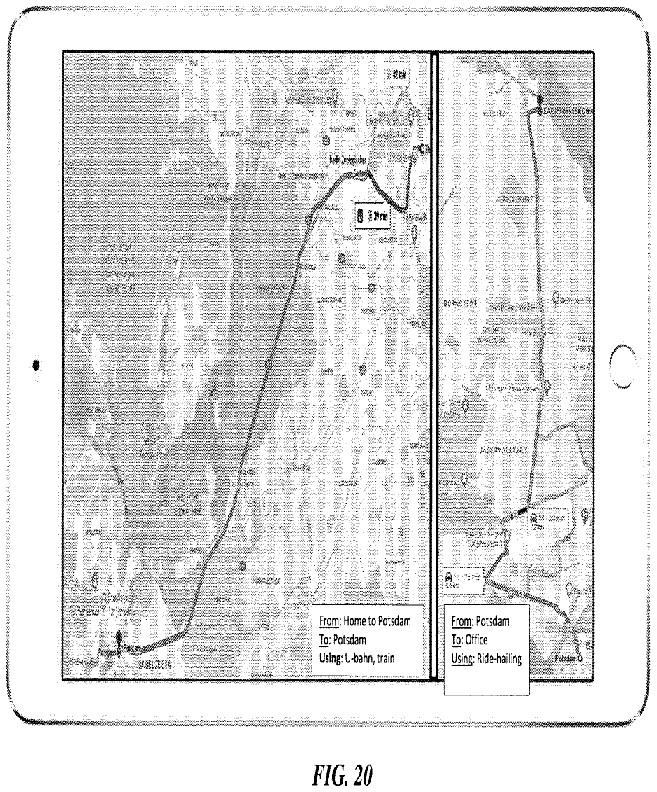

FIG. 19 and FIG. 20 show an example of a mobility measure. In the example, a user travels by a personal car from the user's Home to the user's Office, a distance of 29.7 km. The personal mobility for Monday October 6 is POVMT+29.7+29.7=59.4. Assuming on Tuesday October 6 the user's calendar has the following entries:

1. Meeting at the city office (Winterfeldtstraβe 21, 10781 Berlin, Germany) with John at 10:00 am

2. Lunch meeting with Jim at Lagalante Restaurant (Grunewaldstraβe 82, 10823 Berlin, Germany) at 12:00

3. Meeting at the city office with Jill at 2:00 pm

Assuming that for October 6 the user's to-do list includes the following items:

Grocery shopping: chicken, tomatoes, pasta, bread

Assuming that for that day, the user used the following modalities for the transportation:

1. Home to Office (3.3 km) using a combination of walking and public transportation to arrive in time for the 10:00 am meeting

a. U-bahn from Home (Stadtmitte station) to Bulowstraβe station (2.5 km)

b. Walk from Bulowstraβe station to Office (0.8 km)

2. Walk from the Office to the restaurant to arrive in time for the 12:00 pm lunch (1 km)

3. Walk from restaurant to Office to arrive in time for the 2:00 pm meeting (1 km)

4. Office to Home miles using a combination of walking and public transportation

a. Walk from work to Bulowstraβe station (0.8 km)

b. U-bahn from Bulowstraβe station to Stadtmitte station (home) (2.5 km)

5. Walk from Home to City Supermarkt (Krausenstraβe 11, 10117 Berlin, Germany) (0.8 km)

6. Walk from City Supermarkt to Home (0.8 km)

In the example, PTMT: 5, WMT: 0.8+0.8+0.8+0.8+1+1=5.2, TMT: 5+5.2=10.2, the personal mobility for the user for the given day is 49% walking, 51% public transportation.

Assuming for the rest of week the user had no meetings outside the office and didn't go anywhere outside going from Home to the Office, the mobility measure for a week is 96% privately owned vehicle, 2% public transportation, 2% walking (POVMT: 59.4+59.4+59.4+59.4=237.6, PTMT: 5, WMT: 5.2, TMT: 247.8).

Using the quantification method herein, the mobility measure for an individual is calculated as percentage of the different transportation modes for a given time period.

The distance traveled using the different transportation modes may be provided by the transportation generator. The transportation plan may be created by the Transportation Plan Generator as described elsewhere herein. Alternatively, the above quantification method may be used for processing travel data tracked or generated using any systems. The mobility data provided by the method herein may beneficially provide real-time insights about the percentage of the various transportation modalities at different levels or in different demographic areas.

In FIG. 19, the data about the citizens' ground transportation usage may be tracked and used by the city (e.g., Berliner Verkehrsbetriebe, the city's transportation authority company). Based on the transportation data collected for individuals on a weekly basis, the city's transportation mobility may be: 30% privately-owned vehicles usage, 22% public transportation usage, and 31% walking. Such information may be utilized by the city to adjust the policies or for various goals. For example, assuming the city (e.g., Berliner Verkehrsbetriebe) set a goal for people who use their privately-owned vehicles more than 70% of the time each week to reduce that usage by 20%, the city may offer a 15% discount for the purchase of public transportation a monthly pass, and/or a 20% discount on the use of Uber/Lyft.

In some cases, the Transportation Plan Generator may automatically generate a transportation plan conforming with the goal set by the city. FIG. 20 shows an example of a transportation plan generated based on the goal set by the city (e.g., reducing privately-owned vehicle usage). For example, the Transportation Plan Generator may generate a transportation plan including:

Take the U-bahn from the Stadtmitte station (close to Home) to the Theodor-Heuss-Platz station,

Take the RE1 train to Potsdam,

Use ride-hailing from the Potsdam RE1 train station to Konrad-Zuse-Ring.

In another example, the provided method may be used to promote the use of grocery delivery services and reduce the usage of private vehicles. For example, e-commerce companies may obtain the mobility data and may offer a 10% discount on delivery fee if the individual were to have the groceries delivered to home rather than going to the City Supermarket.

As explained in the examples above, user preferences might be used for filtering route component options prior to submitting bids for route component options to bidders. The bidders might also be filtered to provide a more scalable system rather than having to consider all possible combinations of components and seek bids from providers that clearly cannot provide particular services. Computer systems

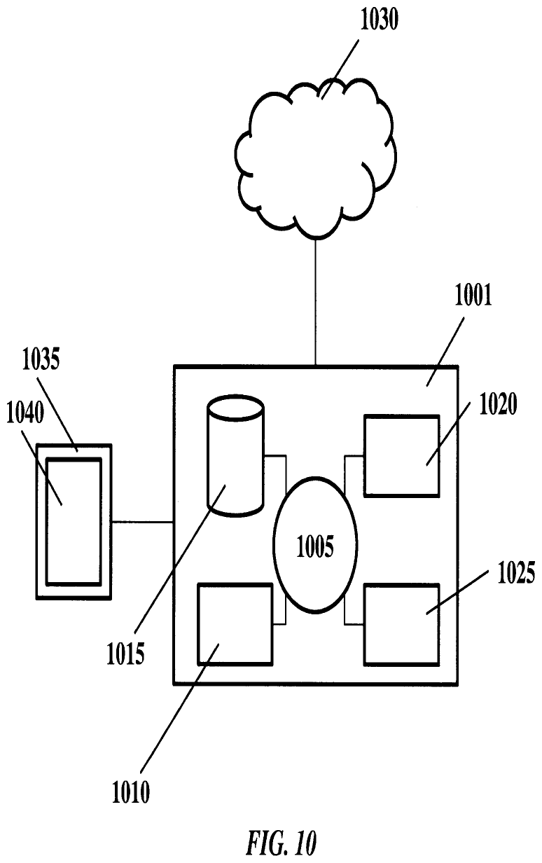

The personal transportation management system, transport plan engine, or processes described herein can be implemented by one or more processors. In some embodiments, the processor may be a processing unit of a computer system. FIG. 10 shows a computer system 1001 that is programmed or otherwise configured to implement the personal transportation management system. The computer system 1001 can regulate various aspects of the present disclosure. The computer system 1001 can be an electronic device of a user or a computer system that is remotely located with respect to the electronic device. The electronic device can be a mobile electronic device.

The computer system 1001 includes a central processing unit (CPU, also “processor” and “computer processor” herein) 1005, which can be a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1125 are in communication with the CPU 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020. The network 1030 can be the Internet, an internet and/or extranet, or an intranet and/or extranet that is in communication with the Internet. The network 1030 in some cases is a telecommunication and/or data network. The network 1030 can include one or more computer servers, which can enable distributed computing, such as cloud computing. The network 1030, in some cases with the aid of the computer system 1001, can implement a peer-to-peer network, which may enable devices coupled to the computer system 1001 to behave as a client or a server.

The CPU 1005 can execute a sequence of machine-readable instructions, which can be embodied in a program or software. The instructions may be stored in a memory location, such as the memory 1010. The instructions can be directed to the CPU 1005, which can subsequently program or otherwise configure the CPU 1005 to implement methods of the present disclosure. Examples of operations performed by the CPU 1005 can include fetc.h, decode, execute, and writeback.

The CPU 1005 can be part of a circuit, such as an integrated circuit. One or more other components of the system 1001 can be included in the circuit. In some cases, the circuit is an application specific integrated circuit (ASIC).

The storage unit 1015 can store files, such as drivers, libraries and saved programs. The storage unit 1015 can store user data, e.g., user preferences and user programs. The computer system 1001 in some cases can include one or more additional data storage units that are external to the computer system 1001, such as located on a remote server that is in communication with the computer system 1001 through an intranet or the Internet.

The computer system 1001 can communicate with one or more remote computer systems through the network 1030. For instance, the computer system 1001 can communicate with a remote computer system of a user (e.g., a user device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), Smart watch, Smart speaker or personal digital assistants. The user can access the computer system 1001 via the network 1030.

Methods as described herein can be implemented by way of machine (e.g., computer processor) executable code stored on an electronic storage location of the computer system 1001, such as, for example, on the memory 1010 or electronic storage unit 1015. The machine executable or machine-readable code can be provided in the form of software. During use, the code can be executed by the processor 1005. In some cases, the code can be retrieved from the storage unit 1015 and stored on the memory 1010 for ready access by the processor 1005. In some situations, the electronic storage unit 1015 can be precluded, and machine-executable instructions are stored on memory 1010.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1001, can be embodied in programming Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1001 can include or be in communication with an electronic display 1035 that comprises a user interface (UI) 1040 for providing, for example, a graphical user interface as described elsewhere herein. Examples of UI's include, without limitation, a graphical user interface (GUI) and web-based user interface.

Methods and systems of the present disclosure can be implemented by way of one or more algorithms An algorithm can be implemented by way of software upon execution by the central processing unit 1005. The algorithm can, for example, trained models such as transport plan engine.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for presenting a personalized transportation plan to a user for multi-modal transportation from an origin location to a destination location, the method comprising:
determining, from the origin location, the destination location, and querying a route component server, a plurality of route data records, wherein a route data record comprises an indication of a plurality of route components that collectively span from the origin location to the destination location, wherein a route component is represented in a route component record comprising at least (1) an indication of a route component start location for the route component, (2) an indication of a route component end location for the route component, and (3) a transportation mode for the route component, and wherein the route component start location for a first route component record of a first route component of the plurality of route components coincides with the origin location and the route component end location for a last route component record of a last route component of the plurality of route components coincides with the destination location;
filtering the plurality of route data records to form a first filtered plurality of route data records, wherein the plurality of route data records is filtered based on a set of user constraints determined from a user profile database;
determining, from the first filtered plurality of route data records and a transportation provider database, a set of transportation option records for a given route component record wherein a given transportation option record of the set of transportation option records indicates a provider of transportation from the route component start location for the route component record to the route component end location for the route component record;
generating at least one bid message, directed to a server operated for a bidding transportation provider indicated in the given transportation option record, representing a request for providing transportation from the route component start location for the route component record to the route component end location for the route component record;
collecting bid responses from servers operated for bidding transportation providers; and
generating the personalized transportation plan based on the plurality of route data records and the bid responses.

2. The method of claim 1, wherein the origin location and/or the destination location are determined from calendar data and/or to-do list data obtained from a device of the user.

3. The method of claim 1, wherein the transportation mode for the route component is selected from the group consisting of an autonomous vehicle trip, a walking trip, a bus trip, a rail trip, a ride-hailing service trip, a private vehicle trip, a ride-sharing trip, a bicycle, and an Internet-connected scooter trip.

4. The method of claim 1, wherein the plurality of route components include waystations, at least one of which is a required waystation and another of which is an optional waystation, and wherein the personalized transportation plan omits the optional waystation for at least one selection of route components.

5. The method of claim 1, wherein a first transportation mode determined for a first route component is different from a second transportation mode determined for a second route component of the plurality of route records.

6. A method for facilitating transportation services, comprising:
at a server, receiving a transportation plan, wherein the transportation plan comprises a plurality of components each including at least a transportation mode, an origin location and a destination location associated with a corresponding component;
querying a transportation provider database to identify one or more service providers based at least in part on the origin location, the destination location and the transportation mode associated with at least one component from the plurality of components; and
sending a bidding request to the one or more transportation providers identified in querying a transportation provider database.

7. The method of claim 6, wherein the transportation plan is a transportation plan generated using a machine learning algorithm trained model and/or generated based at least in part on calendar data, and a to-do list data of the user.

8. The method of claim 6, wherein the transportation mode or the destination location is predicted using a machine learning algorithm trained model.

9. The method of claim 6, further comprising:
receiving one or more bid prices from the one or more service providers; and
transmitting, to a user, the at least one component and multiple transportation options, each including the transportation plan with the one or more bid prices.

10. The method of claim 9, further comprising receiving a user input indicating acceptance of at least one of the multiple transportation options.

11. The method of claim 6, wherein a first transportation mode determined for a first component is different from a second transportation mode determined for a second component of the transportation plan.

12. The method of claim 6, wherein the transportation mode is selected from the group consisting of: an autonomous vehicle, a human-driven automated vehicle, a ride-hailing service, a ride-sharing service, rail transportation, a terrestrial mass transit vehicle, a bicycle, and an Internet-connected scooter.

13. A non-transitory computer-readable storage medium including instructions that, when executed by at least one processor of a computing system, cause the computing system to perform operations comprising:
receiving a transportation plan, wherein the transportation plan comprises a plurality of components each including at least a transportation mode, an origin location and destination location of a respective component;
querying a transportation provider database to identify one or more service providers based at least in part on an origin location, a destination location and a transportation mode associated with at least one component from the plurality of components; and
sending a bidding request to the one or more identified transportation providers.

14. The non-transitory computer-readable storage medium of claim 13, wherein the transportation plan is generated using a machine learning algorithm trained model and/or is generated based at least in part on calendar data, and a to-do list data of a user.

15. The non-transitory computer-readable storage medium of claim 13, wherein the transportation mode or the destination location is predicted using a machine learning algorithm trained model.

16. The non-transitory computer-readable storage medium of claim 13, wherein the computing system is configured to further receive one or more bid prices from the one or more service providers, and transmit the at least one component and transmitting multiple transportation options each including the transportation plan with the one or more bid prices to a user.

17. The non-transitory computer-readable storage medium of claim 16, wherein the computing system is configured to further receive a user input indicating acceptance of at least one of the multiple transportation options.

18. The non-transitory computer-readable storage medium of claim 13, wherein a first transportation mode determined for a first component is different from a second transportation mode determined for a second component of the transportation plan.

19. The non-transitory computer-readable storage medium of claim 13, wherein the transportation mode is selected from the group consisting of: an autonomous vehicle, a human-driven automated vehicle, a ride-hailing service, a ride-sharing service, rail transportation, a terrestrial mass transit vehicle, a bicycle, and an Internet-connected scooter.
